(19) United States
(12) Patent Application Publication
(10) Pub. No.: US 2026/0217190 A1
(43) Pub. Date: Jul. 30, 2026

(54) VEHICULAR DRIVER AND PASSENGER MONITORING SYSTEM AT INTERIOR MIRROR

(71) Applicant: Magna Electronics Inc., Auburn Hills, MI (US)

(72) Inventors: Anuj S. Potnis, Aschaffenburg (DE); Harjeet Singh, Waldaschaff (DE); Matthias Burza, Linköping (SE); Waldemar Kinstler, Kleinheubach (DE)

(21) Appl. No.: 19/459,447

(22) Filed: Jan. 26, 2026

Related U.S. Application Data
(60) Provisional application No. 63/763,321, filed on Feb. 26, 2025.
(60) Provisional application No. 63/759,600, filed on Feb. 18, 2025.
(60) Provisional application No. 63/749,850, filed on Jan. 27, 2025.

(51) Int. Cl. B60R 1/12; B60R 1/04

(52) U.S. Cl. CPC B60R 1/12; B60R 1/04; B60R 2001/1223

(57) ABSTRACT

A vehicular cabin monitoring system includes an interior rearview mirror assembly including a mirror head adjustable about a mounting structure that mounts the interior rearview mirror assembly at an interior portion of an interior cabin of a vehicle. The mirror head accommodates a mirror reflective element and an optical element. A camera is accommodated by the mirror head and views within the interior cabin of the vehicle. The camera has a first field of view including a first region of the cabin and a second field of view including a different second region of the cabin. The camera views at least one of the first region and the second region via the optical element. Image data representative of the first region is processed for monitoring a driver and image data representative of the second region is processed for monitoring a passenger region.

### CROSS REFERENCE TO RELATED APPLICATIONS

The present application claims the filing benefits of U.S. provisional application Ser. No. 63/763,321, filed Feb. 26, 2025, U.S. provisional application Ser. No. 63/759,600, filed Feb. 18, 2025, and U.S. provisional application Ser. No. 63/749,850, filed Jan. 27, 2025, which are hereby incorporated herein by reference in their entireties.

### FIELD OF THE INVENTION

The present invention relates to the field of driver monitoring systems or occupant monitoring systems for vehicles.

### BACKGROUND OF THE INVENTION

It is known to provide a mirror assembly that is adjustably mounted to an interior portion of a vehicle, such as via a single or double ball pivot or joint mounting configuration where the mirror casing and mirror reflective element are adjusted relative to the interior portion of a vehicle by pivotal movement about the single or double ball pivot configuration. The mirror casing and reflective element are pivotable about one or two ball pivot joints by a user that is adjusting a rearward field of view of the reflective element.

### SUMMARY OF THE INVENTION

A vehicular cabin monitoring system includes an interior rearview mirror assembly including a mirror head adjustable about a mounting structure. The mounting structure is configured to mount the interior rearview mirror assembly at an interior portion of an interior cabin of a vehicle. The mirror head accommodates a mirror reflective element and an optical element or a reflecting element. A camera is accommodated by the mirror head, and, with the interior rearview mirror assembly mounted at the interior portion of the interior cabin of the vehicle, the camera views within the interior cabin of the vehicle. The camera views a first region within the interior cabin of the vehicle through the mirror reflective element and the camera views a second region within the interior cabin of the vehicle via the optical element. The camera and the mirror reflective element move together and in tandem with the mirror head when, with the interior rearview mirror assembly mounted at the interior portion of the interior cabin of the vehicle, the mirror head is adjusted about the mounting structure to provide a rearward view for a driver of the vehicle viewing the mirror reflective element. Image data captured by the camera is transferred to an electronic control unit (ECU). The ECU includes electronic circuitry and associated software, and the electronic circuitry of the ECU includes an image processor operable to process image data transferred to the ECU. With the interior rearview mirror assembly mounted at the interior portion of the interior cabin of the vehicle, (i) a first portion of image data captured by the camera and representative of the first region is processed at the ECU for monitoring of the driver of the vehicle and (ii) a second portion of image data captured by the camera and representative of the second region is processed at the ECU for monitoring of a passenger region within the interior cabin of the vehicle. The first portion of image data is representative of a first field of view of the camera that includes the first region of the interior cabin of the vehicle, and the second portion of image data is representative of a second field of view of the camera that includes the second region of the interior cabin of the vehicle, and wherein the second region of the interior cabin of the vehicle is different from the first region of the interior cabin of the vehicle

These and other objects, advantages, purposes and features of the present invention will become apparent upon review of the following specification in conjunction with the drawings.

### BRIEF DESCRIPTION OF THE DRAWINGS

FIG. 1A is a sectional view of a first interior rearview mirror assembly having a first camera that views through a mirror reflective element of the mirror assembly and a second camera that views downward through an aperture in a mirror casing of the mirror assembly;

FIG. 1 B is a sectional view of a second interior rearview mirror assembly having a single camera that views through the mirror reflective element and that views downward through an aperture in the mirror casing via a beam splitter;

FIG. 2 shows a primary field of view and a blind spot of the first camera of the first interior rearview mirror assembly of FIG. 1A;

FIG. 3 is a perspective view of an interior rearview mirror assembly having a driver monitoring camera and a near infrared light emitter behind a reflective element of the interior rearview mirror assembly;

FIG. 4 is another perspective view of the interior rearview mirror assembly, showing the driver monitoring camera and light emitters without the reflective element;

FIG. 5 is a schematic view of the interior rearview mirror assembly, with a reflecting element disposed at the mirror reflective element for directing light to the camera representative of a secondary field of view;

FIG. 6 is a plan view of a vehicle equipped with the cabin monitoring system and showing primary and secondary fields of view of the camera;

FIG. 7 is a schematic view of an example image frame captured by the camera;

FIG. 8 is a schematic diagram of light captured by the camera;

FIG. 9 is a schematic view of the interior rearview mirror assembly, with a beam splitter for directing light to the camera representative of the primary field of view and the secondary field of view;

FIG. 10 is a schematic view of the interior rearview mirror assembly, with a polarizing beam splitter and a polarization selector for alternating between directing light to the camera representative of the primary field of view and directing light to the camera representative of the secondary field of view;

FIG. 11 is a schematic view of the interior rearview mirror assembly, with the camera having sets of pixels respectively sensitive to first and second polarization states;

FIG. 12 is a schematic view of the interior rearview mirror assembly, with the camera having a primary viewing angle through the mirror reflective element;

FIG. 13 is a schematic view of the interior rearview mirror assembly, with the camera having a primary viewing angle generally downward from the mirror head and not through the mirror reflective element;

FIG. 14 is a schematic view of the interior rearview mirror assembly, with near infrared light emitters illuminating the primary field of view and the secondary field of view and with the beam splitter directing near infrared light reflected from the primary field of view and the secondary field of view to the camera;

FIG. 15 is a schematic view of the interior rearview mirror assembly, with near infrared light emitters illuminating the primary field of view and the secondary field of view in alternating time intervals and with the beam splitter directing near infrared light reflected from the primary field of view and the secondary field of view to the camera;

FIG. 16 is a schematic view of the interior rearview mirror assembly, with optical shutters blocking and unblocking the primary field of view and the secondary field of view in alternating time intervals and with the beam splitter directing light reflected from the primary field of view and the secondary field of view to the camera;

FIG. 17 is a schematic view of the interior rearview mirror assembly, with lenses disposed at a beam splitter for directing light to the camera representative of the primary field of view and the secondary field of view;

FIG. 18 is a schematic view of the interior rearview mirror assembly, with a lens disposed at a beam splitter for directing light to the camera representative of the primary field of view and a light and optical relay disposed at the beam splitter for directing light to the camera representative of the secondary field of view;

FIG. 19 is a schematic view of the interior rearview mirror assembly, with lenses and optical relays disposed at a beam splitter for directing light to the camera representative of the primary field of view and the secondary field of view;

FIG. 20 is a schematic view of the interior rearview mirror assembly, showing an optical path of light to the camera via the optical relay and beam splitter;

FIG. 21 is a schematic view of the optical relay; and

FIG. 22 is a schematic view of a single camera with a blind spot, and the beam splitter that simultaneously transmits light to the camera for a primary field of view and reflects light to the camera for a secondary field of view including the blind spot.

### DESCRIPTION OF THE PREFERRED EMBODIMENTS

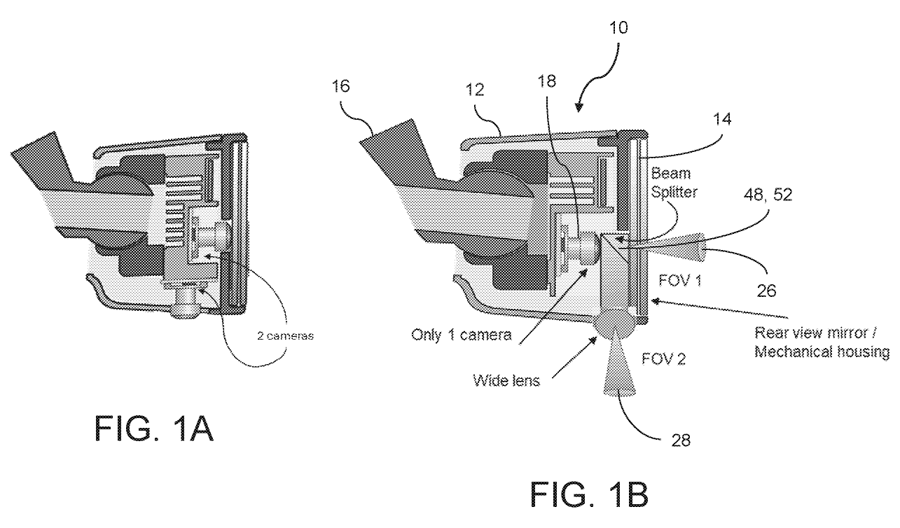

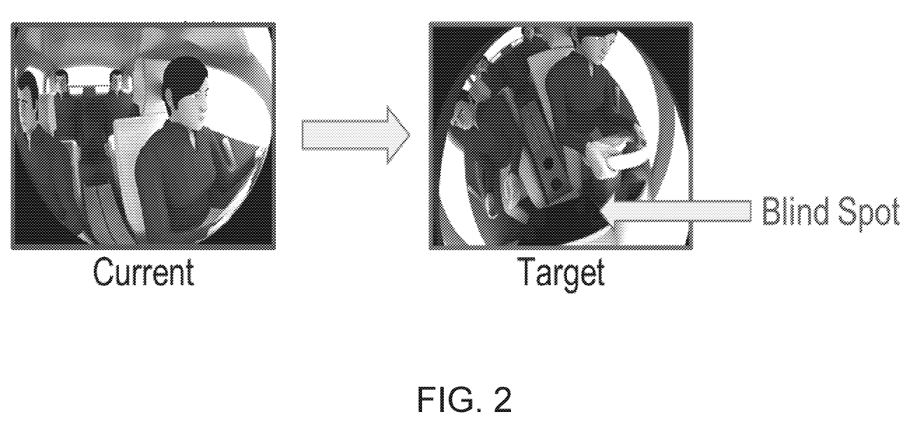

Vehicles equipped with sensors such as cameras, radar sensors and lidar sensors monitor both the environment outside and the interior of the vehicle and yet traditionally have blind spots outside the field of sensing of the sensors. For driver monitoring systems (DMS) and occupant monitoring systems (OMS), a camera is typically positioned inside or near the interior rear view mirror assembly, focusing on the driver's upper body and partially on the front passenger (FIGS. 1A, 1B and 2). A notable blind spot for typical DMS/OMS is directly beneath the interior rearview mirror assembly, which includes critical areas like the hands, laps, knees, feet, and footwells for the driver and front passenger. Monitoring these areas is important, especially for airbag deployment to determine the position and proximity of body parts relative to the airbag and for seat belt restraint. The blind spot may also include the dashboard and drivers may place their mobile phone or other device on the dashboard, such as for navigation. For example, FIG. 2 shows that the field of view of the DMS/OMS camera traditionally covers the upper body of the driver and a portion of the front and/or rear passengers, but the footwells of the driver and passengers are blind spots.

In particular, passenger safety is a critical aspect of overall vehicle safety, yet traditional monitoring systems may focus solely on the driver. That is, a driver monitoring system may include a camera that captures images representative of a driver region of the interior cabin of the vehicle and the front passenger may only be partially visible in images captured by the monitoring system. To monitor the front passenger, the system may include additional cameras and sensors (such as an additional downward-facing camera in FIG. 1A), increasing the complexity and cost of the system. Moreover, these systems typically may not provide comprehensive monitoring due to limited field of view and single- mode detection methods. That is, these systems may only detect one aspect at a time (e.g., a head of the driver).

As discussed further below, an occupant monitoring system leverages a driver monitoring camera to monitor a front passenger of the vehicle. By incorporating an optical component in front of the camera that both transmits and reflects light, like a prism or mirror or beam splitter, the system reflects or deflects light to extend the driver monitoring camera's field of view, enabling image data captured by the camera to be processed for monitoring both the driver and the front passenger of the vehicle. This allows a single camera to capture two different fields of view at the same time. Thus, this use of optical components allows for a more efficient and cost-effective solution. In other words, a single mirror-mounted camera utilizing the dual-field of view innovations of the present disclosure achieves a downward field of view into where a blind spot exists without addition of a second camera. This reduces cost and complexity by incorporating an optical component, such as a beam splitter, in front of the camera that both transmits and reflects light. This allows the single camera to capture two different fields of view at the same time.

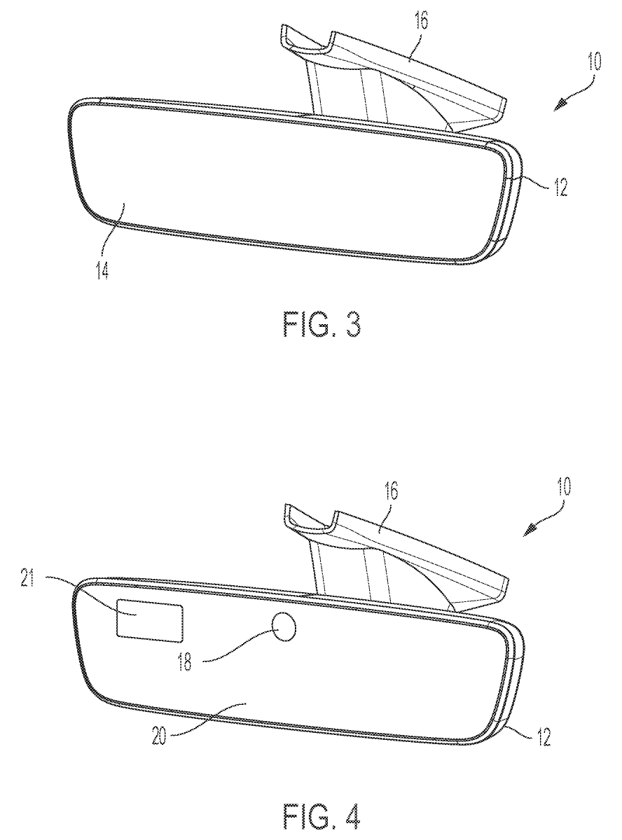

Referring now to the drawings and the illustrative embodiments depicted therein, an interior rearview mirror assembly 10 for a vehicle 11 includes a casing 12 and a reflective element 14 positioned at a front portion of the casing 12 (FIGS. 1B and 3-6 ). In the illustrated embodiment, the mirror assembly 10 is configured to be adjustably mounted to an interior portion of the vehicle 11 (such as to an interior or in-cabin surface of a vehicle windshield or a headliner of the vehicle or the like) via a mounting structure or mounting configuration or assembly or stay 16. The system includes a camera 18 disposed at and movable with the mirror head. For example, the camera 18 may be disposed behind the mirror reflective element 14 and view through the mirror reflective element 14 for capturing image data representative of the interior cabin of the vehicle 11, including the driver's head region and occupant region of the vehicle cabin. The system may utilize aspects of driver monitoring systems or occupant monitoring systems described in U.S. Pat. Nos. 11,930,264; 11,827,153; 11,780,372 and/or 11,639,134, and/or International Publication Nos. WO 2026/019985 and/or WO 2023/220222, which are all hereby incorporated herein by reference in their entireties.

The mirror assembly 10 includes or is associated with a driver monitoring system (DMS), an occupant monitoring system (OMS) and/or a cabin monitoring system, with the mirror assembly 10 comprising the driver/occupant monitoring camera 18 disposed at a back plate 20 (and viewing through an aperture of the back plate) behind the reflective element 14 and viewing through the reflective element 14 toward at least a head region of the driver of the vehicle 11. That is, the driver monitoring camera 18 is accommodated by the mirror head, and with the mounting structure 16 attached at the interior portion of the cabin of the vehicle 11, the driver monitoring camera views within the cabin of the vehicle 11 toward at least the head region of the driver. The DMS may include an infrared light (IR light) or near infrared light (near IR light) emitter 21 disposed at the back plate and emitting IR light or near IR light that passes through another aperture of the back plate and through the reflective element 14.

Image data captured by the DMS/OMS camera 18 may be transferred to an electronic control unit (ECU) that includes electronic circuitry and associated software, including an image processor for processing image data captured by the DMS/OMS camera 18. The ECU may be disposed at or within the mirror assembly 10, or the ECU may be disposed remote from the mirror assembly 10 (e.g., a vehicle domain controller) and image data may be transferred from the DMS/OMS camera 18 to the remote ECU, such as via a coaxial cable. The image data captured by the camera 18 may be processed at the ECU for DMS and/or OMS functions, such as for a head and face direction and position tracking system and/or eye tracking system and/or gesture recognition system. Optionally, the DMS/OMS camera may be disposed at other portions of the interior cabin of the vehicle, such as at a windshield-mounted electronics module (WEM), at the mounting structure 16 of the mirror assembly, at the headliner of the vehicle, and the like, where the mounting position of the camera allows the camera to view the driver and/or one or more passengers of the vehicle.

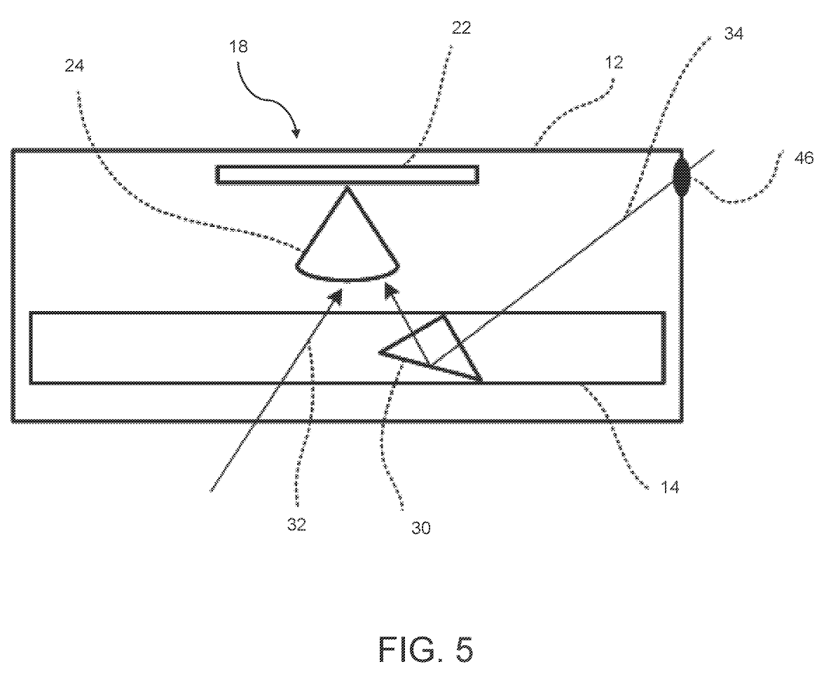

Referring to FIGS. 5-8, the camera 18 is disposed within the mirror head or casing 12 and views through the mirror reflective element 14 of the mirror assembly. The camera 18 includes an imager 22 (e.g., disposed at a printed circuit board (PCB) of the camera assembly) and a lens or optical element 24 aligned with the imager 22. The imager 22 views through the lens 24 and the mirror reflective element 14 to view a first region or a primary region 26 (e.g., a region within the interior cabin of the vehicle that includes at least a driver's head region) and the imager 22 may view a second region or a secondary region 28 (e.g., a region within the interior cabin of the vehicle that includes a passenger seating region) via reflections directed toward the imager 22 by a prism or mirror element 30. That is, the imager 22 captures image data and a first portion of the image data may be representative of light 32 that passes through the mirror reflective element 14 (i.e., transmitted light) and is representative of the first region 26 viewed by the camera 18 and a second portion of the image data may be representative of light 34 that is directed toward the imager 22 by the prism 30 (i.e., reflected light) and is representative of the second region 28 viewed by the camera 18. The prism 30 may be disposed within a first field of view of the imager 22 that views the first region 26. The prism 30 may be disposed within the casing or mirror head 12 of the mirror assembly 10 or the prism 30 may be disposed outside the casing 12. The prism 30 may direct or reflect light toward the imager 22 via total internal reflection.

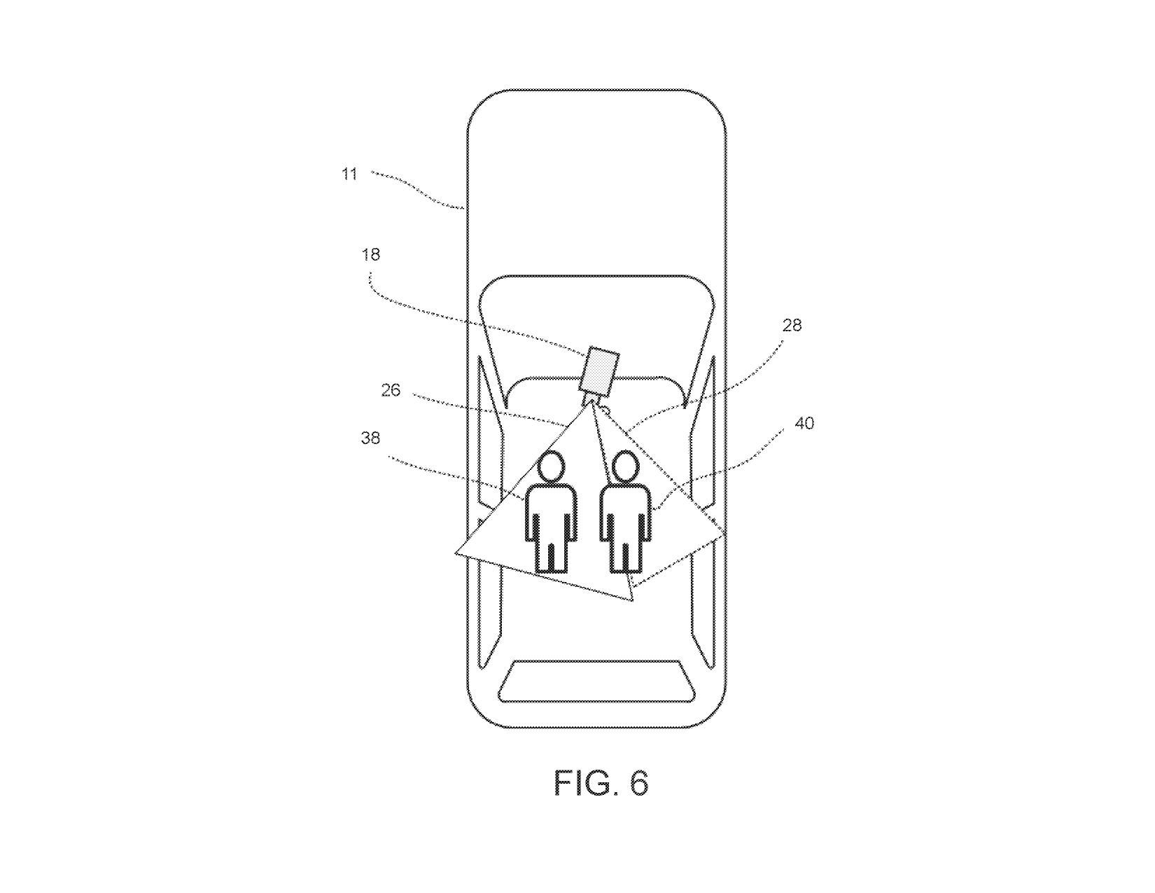

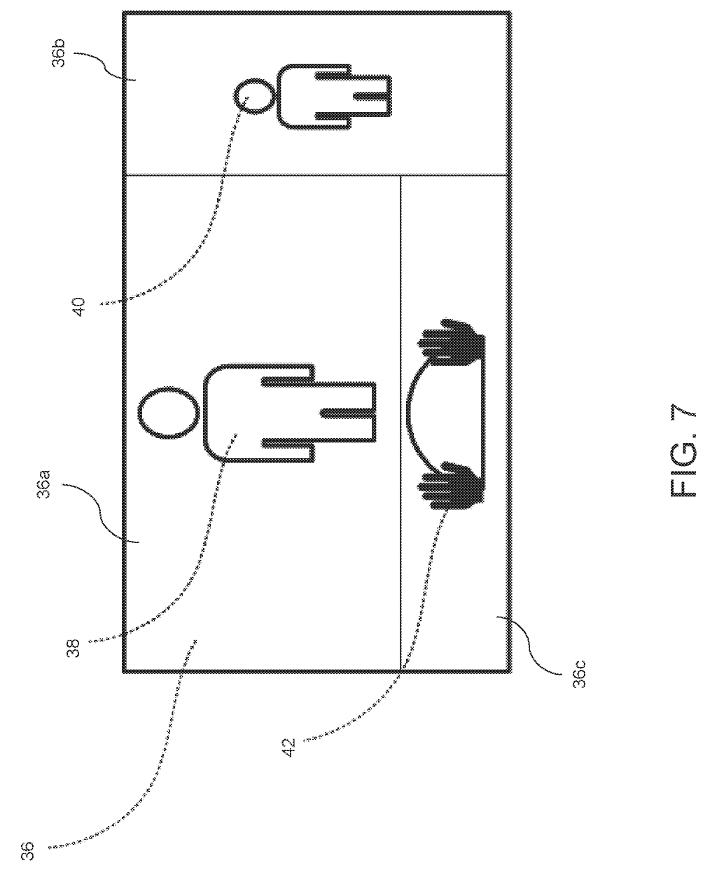

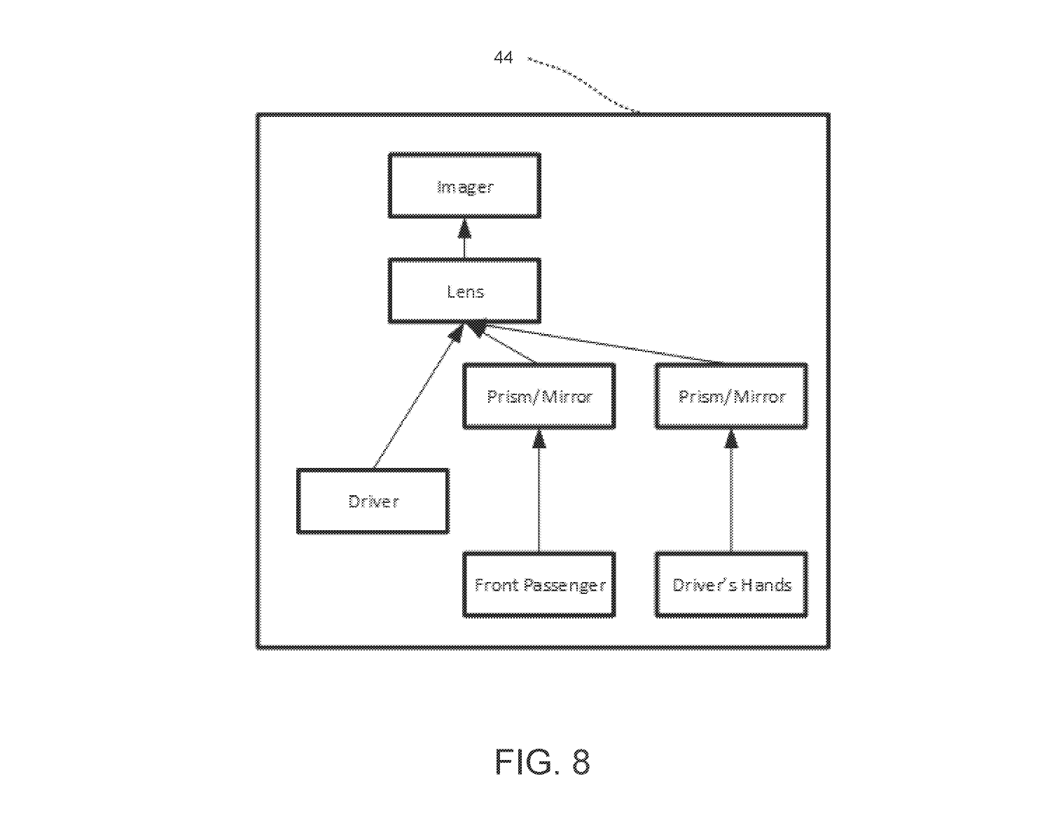

Thus, and as shown in FIGS. 6 and 7, the camera 18 may capture frames 36 of image data representative of the first region 26 and the second region 28. A first portion or region 36a of the image frame 36 may be representative of the first region 26 and allow the system to view a driver 38 of the vehicle 11. A second portion or region 36b of the image frame 36 may be representative of the second region 28 and allow the system to view a front passenger 40 of the vehicle 11. Optionally, the image frames 36 may include portions representative of other fields of view or regions of the interior cabin of the vehicle. For example, a third portion or region 36c of the image frame 36 may allow the system to view a driver's hand or steering wheel region 42 of the vehicle 11. A plurality of prisms may be disposed at or near the mirror assembly 10 to extend the field of view of the camera 18 and allow the system to monitor the front passenger 40, the driver's hands 42, and/or other areas not typically covered by the driver monitoring camera 18 alone. As shown in FIG. 8, a schematic 44 shows the light that reaches the imager 22 may be representative of the driver 38, the front passenger 40, and the driver's hands 42, with the light representative of the driver 38 passing through the lens 24 to be imaged by the camera 18, and with the light representative of the passenger 40 and the driver's hands 42 directed to the lens 24 by one or more prisms 30 to be imaged by the camera 18.

The prism 30 may direct light 34 that passes through the mirror reflective element 14 toward a portion of the imager 22. For example, the prism 30 may be integrally formed with the mirror reflective element 14 or a separate optical piece attached at the mirror reflective element 14. In some examples, the prism 30 may direct light that passes through an aperture or hole or cutout 46 in the mirror housing or casing toward the imager 22 (FIG. 5). For example, the aperture 46 may be formed at a lower portion of the mirror casing 12 and allow the camera 18 to view the driver's hands 42 via light 34 that passes through the aperture 46 and is directed toward the imager 22 via the prism 30.

Images 36 captured by the camera 18 are processed for DMS functions and/or OMS functions, such as to determine a gaze direction of the driver 38, determine a pose of the front passenger 40, determine a hand position of the driver 38 at or near the steering wheel, and the like. The system may collectively process the portions of the image 36. Optionally, the system may process each portion of the image 36 separately from one another. For example, the system may process the first portion 36a and the third portion 36c for determining an attentiveness level of the driver 38 and the system may process the second portion 36b for determining a pose of the front passenger 40 of the vehicle 11.

Optionally, the system may enable or disable processing respective portions of the image 36. For example, based on determination that no front passenger is present in the vehicle 11, the system may not process the second portion 36b of the image frame 36, such as to conserve processing resources. In other words, image signal processing may be performed individually on each field of view, and the system may enable or disable use of the prism 30 for particular frames of image data. Image processing, artificial intelligence, and/or machine learning algorithms may work on each field of view separately or collectively to make more intelligent decisions based on comprehensive data.

In some examples, the prism 30 may be adjusted or moved relative to the camera 18 and/or the mirror reflective element 14 or mirror casing 12 to adjust the region of the interior cabin of the vehicle 11 viewed via the prism 30. The prism 30 may be rotated or pivoted or tilted or translated to adjust the optical path or angle of the light 34 directed toward the imager 22 by the prism 30 and thus adjust the region 28 viewed via the prism 30. Optionally, the prism 30 may be adjusted based on processing of image data captured by the camera 18 and representative of the second region 28 viewed via the prism 30. For example, the prism 30 may be adjusted based on a position of a detected vehicle occupant in the captured image data (e.g., to center the occupant in the frame of image data and/or to change the occupant viewed in the frame of image data). The prism 30 may be adjusted to focus and/or align the optical path of light 34 from the prism 30 at the imager 22 of the camera 18. That is, the prism 30 may be moved, such as oscillated or rotated, to provide precise control of the field of view. Thus, the prism 30 may be used to turn on/off the optical path and to also specify the direction of the optical path of the camera 18.

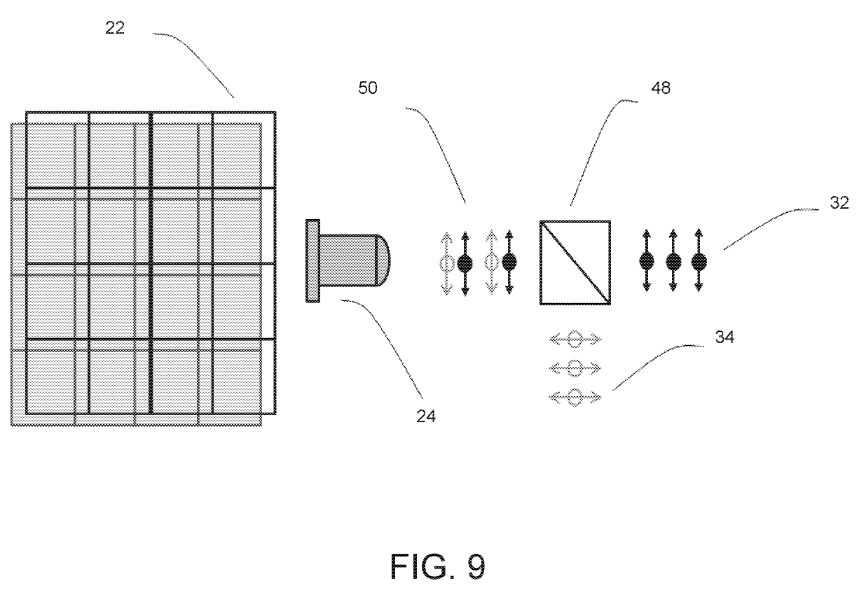

Referring to FIG. 9, the mirror assembly 10 may include a partially transparent optic 48, such as a beam splitter like a cube beam splitter or a flat or plate beam splitter, that directs light toward the imager 22 so that two or more fields of view may be superimposed and imaged simultaneously at the imager 22 of the camera 18. The beam splitter or beam-splitting prism may comprise a high-quality optical glass with one or more partial reflective coatings on internal surfaces of the prism and/or one or more anti- reflective coatings on entry or exit surfaces of the prism. Light enters the beam splitter 48 and encounters a partially reflective surface inside the splitter. Part of the light is transmitted through the partially reflective surface and part of the light is reflected at an angle.

In the illustrated example, the light 32 representative of the first region 26 may be incident at a first portion or first face of the partially transparent optic 48 and the light 34 representative of the second region 28 may be incident at a second portion or second face of the partially transparent optic 48. The light 32 representative of the first region 26 may pass through the mirror reflective element 14 and the light 34 representative of the second region 28 may pass through the aperture 46 in the mirror head 12 or pass through another portion of the mirror reflective element 14.

At least a portion of the light 32 representative of the first region 26 and at least a portion of the light 34 representative of the second region 28 may be reflected or directed by the partially transparent optic 48 and/or pass through the partially transparent optic 48 to be incident at the imager 22. For example, the partially transparent optic 48 may include both prisms and surfaces dedicated to at least partially reflect some of the light incident at the partially transparent optic 48. The partially transparent optic 48 may direct a combined beam of light or combined image 50 to the imager 22. The combined image 50 comprises a portion of the light 32 representative of the first region 26 and a portion of the light 34 representative of the second region 28 while other portions of the light 32, 34 may be reflected by or passed through the partially transparent optic 48 and not incident at the imager 22. Thus, the field of view representative of the first region 26 and the field of view representative of the second region 28 may be imaged simultaneously at the imager 22.

Image data corresponding to the respective fields of view may be captured at different portions of the imager 22 (i.e., different pixels) or at overlapping portions of the imager 22. Processing algorithms (e.g., artificial intelligence (AI) processing algorithms) may process the captured image data to distinguish features inherent to individual fields of view. The partially transparent optic 48 may be disposed at or integrally formed with the mirror reflective element 14 and/or disposed at the aperture 46 formed through the mirror casing 12 of the mirror assembly 10. The lens or optical element 24 may be disposed between the partially transparent optic 48 and the imager 22.

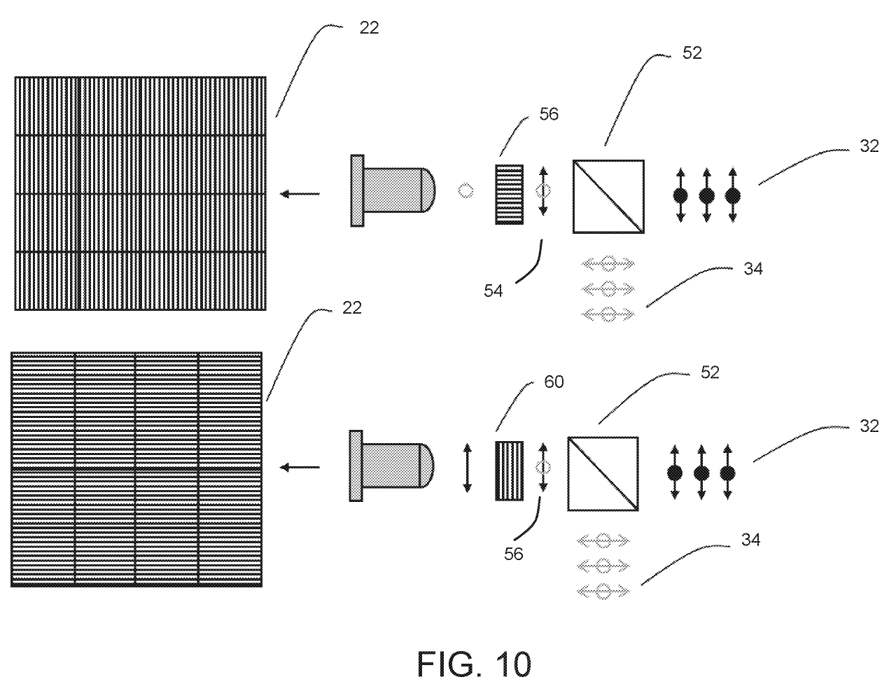

As shown in FIG. 10, the mirror assembly 10 may further include a polarizing optic or beam splitter 52 that directs a combined beam of light or combined image 54 to the imager 22. To form the combined image 54, the light 32 representative of the first region 26 is incident at the polarizing beam splitter 52 and passes through or is directed by the polarizing beam splitter 52 toward the imager 22 having a first polarization (e.g., an S orthogonal polarization state). The light 34 representative of the second region 28 is incident at the polarizing beam splitter 52 and passes through or is directed by the polarizing beam splitter 52 toward the imager 22 having a second polarization state (e.g., a P orthogonal polarization state).

The polarizing beam splitter 52 is an optical device that may split an incoming light beam into two separate beams based on polarization state of the light. The beam splitter 52 may transmit light of one polarization (usually linear, like P-electric field horizontal to the plane of incidence) while reflecting light of another polarization (such as S-electric field that is orthogonal to the plane of incidence). The beam splitter 52 may include birefringent materials or multilayer dielectric coatings. The polarizing beam splitter 52 may combine optical substrates with polarization-selective structures so that one polarization state is transmitted while the orthogonal state is reflected. The beam splitter 52 may include a multi-layer thin film stack of dielectric thin films comprising alternating layers of a high refractive index material, such as TiO2 (Titanium dioxide) or Ta2Os (Tantalum pentoxide), and a lower refractive index material, such as SiO2 (Silicon dioxide). Optionally, the beam splitter 52 may comprise a birefringent crystal polarizing beam splitter. For a thin film polarizing beam splitter, a cube beam splitter can be formed with two right angle prisms with the polarizing multi-layer stack deposited on the hypotenuse of one prism and with the two prisms joined one to another (such as by an optical adhesive) to form a cube. The interface formed becomes the polarization-splitting plane that splits polarization at 90 degrees. Alternatively, a plate-type polarizing beam splitter can be used or a birefringent crystal polarizing beam splitter can be used. A cube polarizing beam splitter may be preferred.

A cube polarizing beam splitter may achieve a symmetric, 50:50 beam split. In some examples, other optic elements may achieve an asymmetric beam split. For example, the field of view of the camera 18 accommodated by the interior rearview mirror assembly may be split with (i) 90 percent of the field of view viewing the driver and the torsos of passenger(s) seated in the front seating region or in the rear seating region within the interior cabin of the equipped vehicle and (ii) 10 percent of the field of view viewing downward below the mirror head of the interior rearview mirror assembly to monitor the footwell region in front of the driver and front passenger seats and below the facia of the vehicle. For example, a non-polarizing beam splitter with a 90:10 dielectric coating can be used, forming a non-polarizing beam splitter with a custom partial-reflective coating designed for 90 percent transmission and 10 percent reflection.

A polarization selector or a polarizer / analyzer 56 is disposed between the polarizing beam splitter 52 and the imager 22 for adjusting the portion of the combined image 54 viewed by the imager 22. In other words, the polarization selector 56 is operable between a first state, where light incident at the polarization selector 56 having the first polarization state passes through the polarization selector 56 and light having the second polarization state is blocked from passing through, and a second state, where light incident at the polarization selector 56 having the second polarization state passes through the polarization selector 56 and light having the first polarization state is blocked from passing through. Thus, with the polarization selector 56 in the first state, the imager 22 views the first field of view representative of the first region 26 and, with the polarization selector 56 in the second state, the imager 22 views the second field of view representative of the second region 28.

By rapidly switching the polarization selector 56 between the first state and the second state and processing captured frames of images that correspond to the first state and the second state, the system may view both regions of the vehicle using the same imager 22. For example, by processing image data captured with the selector 56 in the first state, the system may perform driver monitoring functions. By processing image data captured with the selector 56 in the second state, the system may perform occupant monitoring functions.

That is, the polarizing beam splitter 52 is introduced into the beam path between the camera 18 and the primary object so that light from two separate fields of view feature orthogonal polarizations. The polarizer / analyzer 56 is introduced between the splitting objects and the photodiode of the sensor 22 to select either field of view. For example, the polarization selector 56 may include liquid crystal technology or a similar electro-optical shutter (such as an electrochromic or suspended particle shutter) for rapidly adjusting between the first state and the second state.

Optionally, the light 32 representative of the first region 26 and the light 34 representative of the second region 28 may pass through the polarizing beam splitter 52, such as a Wollaston prism, such that the combined image 54 is viewed by the camera 18 as orthogonally polarized light with the two portions of the image separated by a fixed polarization angle. The polarized light representative of the first region 26 and the polarized light representative of the second region 28 may be separated or separately processed in post processing based on the known deviation between the polarization angles.

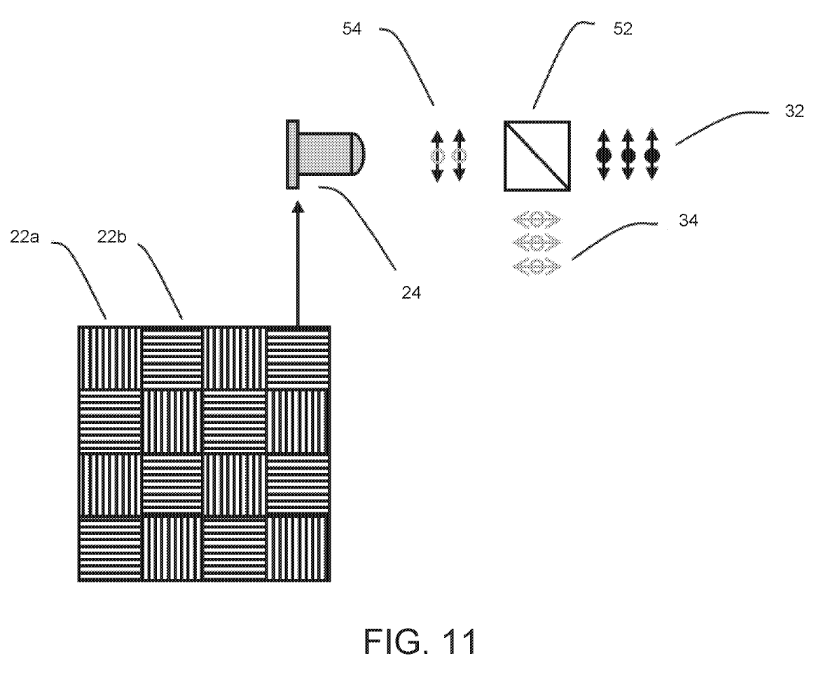

Optionally, and such as shown in FIG. 11, the imager 22 may include a polarization-sensitive sensor where subgroups of pixels of the imager 22 may be sensitive to certain polarizations. For example, the imager 22 may include a first set of or portion of pixels or photodiodes 22a that capture image data representative of light having the first polarization state and a second set of or portion of pixels or photodiodes 22b that capture image data representative of light having the second polarization state. The first set of pixels 22a and the second set of pixels 22b may be dispersed evenly or uniformly across the imager 22, or the first set of pixels 22a and the second set of pixels 22b may be disposed at respective portions of the imager 22 configured to capture the respective images (e.g., an upper portion and a lower portion of the imager). Accordingly, different fields of view may be read from the sensor 22 by selectively reading those pixels corresponding to the field of view. The polarization-sensitive sensor requires no moving parts, providing a robust implementation.

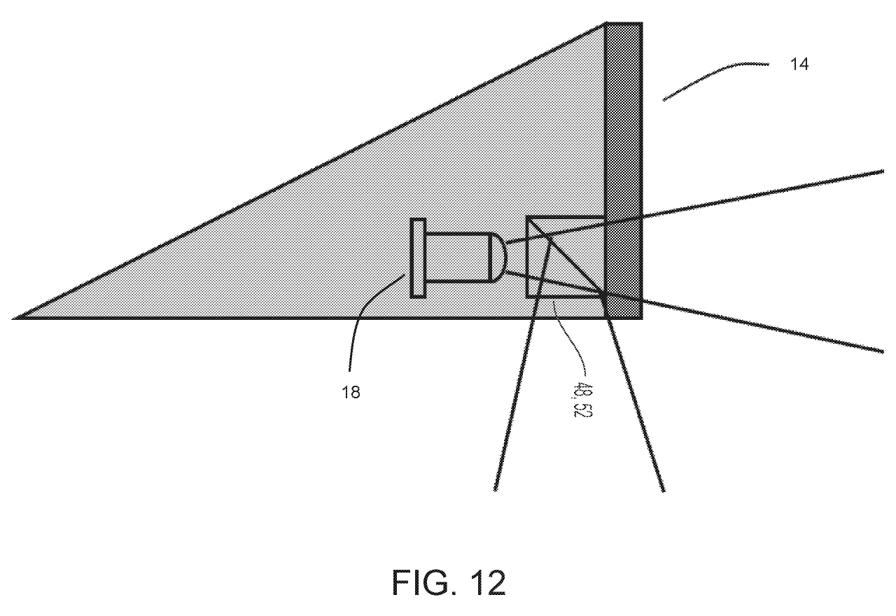

As shown in FIG. 12, the camera 18 may view through the partially transparent optic 48 and/or the polarizing beam splitter 52 and the mirror reflective element 14. The partially transparent optic 48 and/or the polarizing beam splitter 52 may be disposed at or integrally formed with the mirror reflective element 14, such as at a rear side or inner portion of the mirror reflective element 14. The primary viewing angle of the camera 18 may be generally rearward of the mirror assembly and through the mirror reflective element 14 and a secondary viewing angle of the camera 18 provided by the reflections of the transparent optic 48 or polarizing beam splitter 52 may be generally downward from the mirror head 12 toward the front passenger region of the cabin of the vehicle 11.

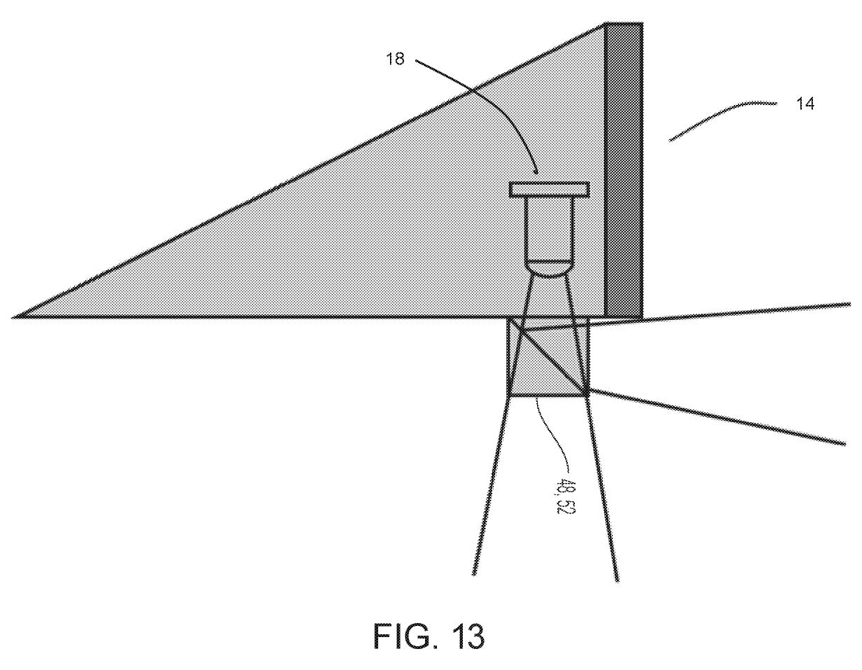

Optionally, and such as shown in FIG. 13, the camera 18 may view through the partially transparent optic 48 and/or the polarizing beam splitter 52 for viewing both the first region 26 and the second region 28 of the interior cabin of the vehicle 11. The partially transparent optic 48 or polarizing beam splitter 52 may be disposed beneath or at a lower edge region of the mirror reflective element 14. In other words, the primary viewing angle of the camera 18 may be generally downward toward the front passenger region of the cabin of the vehicle 11 and the secondary viewing angle of the camera 18 provided by the reflections of the transparent optic 48 or polarizing beam splitter 52 is generally rearward of the mirror assembly 10 to view the driver region of the cabin of the vehicle. Here, the camera 18 does not view through the reflective element 14.

In other words, double imaging provided by the partially transparent optic 48 and/or the polarizing beam splitter 52 may be applied as an addition to the primary DMS camera optical path. This may complete DMS functionality with passenger monitoring through the additional field of view. Optionally, a more complex secondary passenger monitoring system may be dedicated to passenger monitoring. The splitting optics 48, 52 may be produced as an additional optical component or part of the rearview mirror substrate. That is, the mirror assembly 10 may include the primary DMS camera that views through the mirror reflective element 14 for viewing the driver of the vehicle and the mirror assembly 10 may include a secondary camera for viewing one or more passengers of the vehicle, such as via reflections or portions of image data provided by the partially transparent optic 48 and/or the polarizing beam splitter 56, such as by utilizing characteristics of the mirror assemblies described in International Publication No. WO 2026/019985, which is hereby incorporated herein by reference in its entirety.

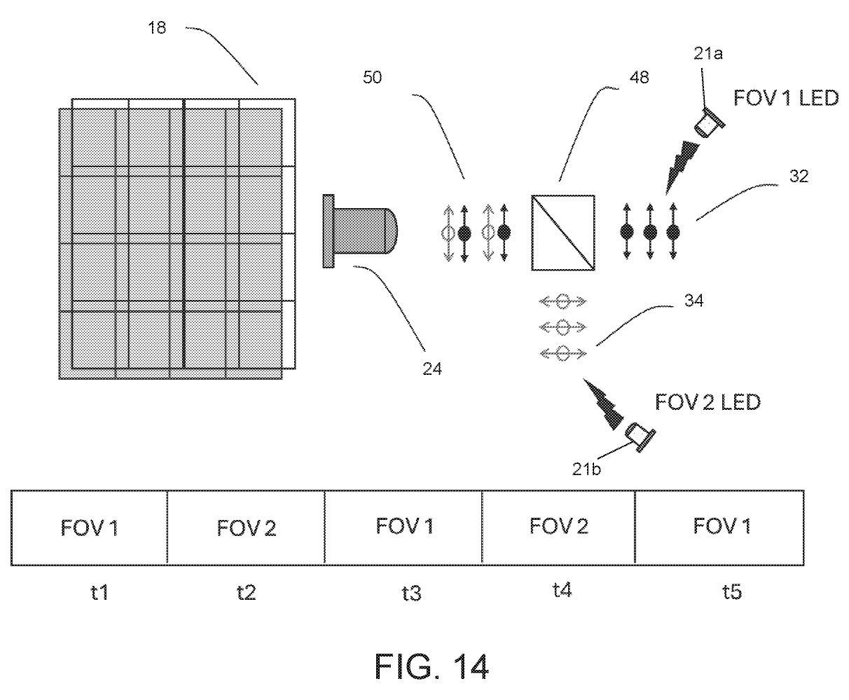

In some examples, at least one region of the interior cabin of the vehicle 11 may be illuminated by near infrared light or by infrared light (e.g., light having a wavelength between about 600 nanometers and 1,000 nanometers), such that the camera 18 captures image data representative of near infrared light reflected from surfaces, objects, and passengers within the cabin of the vehicle 11. Referring to FIG. 14, a light emitter within the cabin of the vehicle 11, such as the light emitter 21 at the mirror assembly 10, is electrically operable to emit infrared light or near infrared light. Optionally, separate light emitters (disposed at or near one another, such as at the mirror assembly 10, or disposed elsewhere in the vehicle 11 remote from one another, such as at the headliner of the vehicle 11, an overhead console module, a grab handle, and the like) may be operable to illuminate respective regions within the cabin of the vehicle 11. The light 32 representative of the first region 26 and/or the light 34 representative of the second region 28 may include near infrared light and/or visible light reflected from objects within the interior cabin of the vehicle 11. Thus, the combined image 50 directed toward the camera 18 by the partially transparent optic 48 may include near infrared light and/or visible light representative of the first region 26 and near infrared light and/or visible light representative of the second region 28. The camera 18 may be configured to capture image data representative of near infrared light and/or visible light. In some examples, one of the separate light emitters may emit a different spectrum of light than the other of the separate light emitters. For example, one light emitter may emit visible light, and the other light emitter may emit near-infrared light. Alternatively, one light emitter may emit near-infrared light, and the other light emitter may emit infrared light. In other examples, each light emitter may emit a different wavelength of light within the same spectrum of visible light, near-infrared light, or infrared light.

To separate portions of the captured image data representative of the two different regions, the regions may be illuminated in an alternating time-shared manner. For example, the first region 26 and the second region 28 may be illuminated by pulsing two different infrared light sources, where the pulses of the light sources are offset or alternating relative to one another. Further, the pulses may correspond to a frame rate of image data capture by the camera 18, such that a first frame of image data (e.g., at t1, t3, and t5 in FIG. 14) is captured when the first region 26 is illuminated by a first light source (i.e., the first frames of image data are captured when the first light source is pulsed on), with the first frame of image data being representative of a greater portion of light reflected from the first region 26 and a subsequent second frame of image data (e.g., at t2 and t4 in FIG. 14) is captured when the second region 28 is illuminated by a second light source (i.e., the second frames of image data are captured when the second light source is pulsed on), with the second frame of image data being representative of a greater portion of light reflected from the second region 28. Thus, the system may process image data captured when the first region 26 is illuminated to view the first region 26 and may process image data captured when the second region 28 is illuminated to view the second region 28.

Optionally, the light emitters illuminating the first region 26 and the second region 28 may emit different wavelengths of light, such as different wavelengths of near infrared light. Thus, image data captured by the camera 18 and representative of light of a first wavelength may be processed to view the first region 26. Image data captured by the camera 18 and representative of a different second wavelength may be processed to view the second region 28. The image data may be separated or separately processed in post processing using image processing and/or AI.

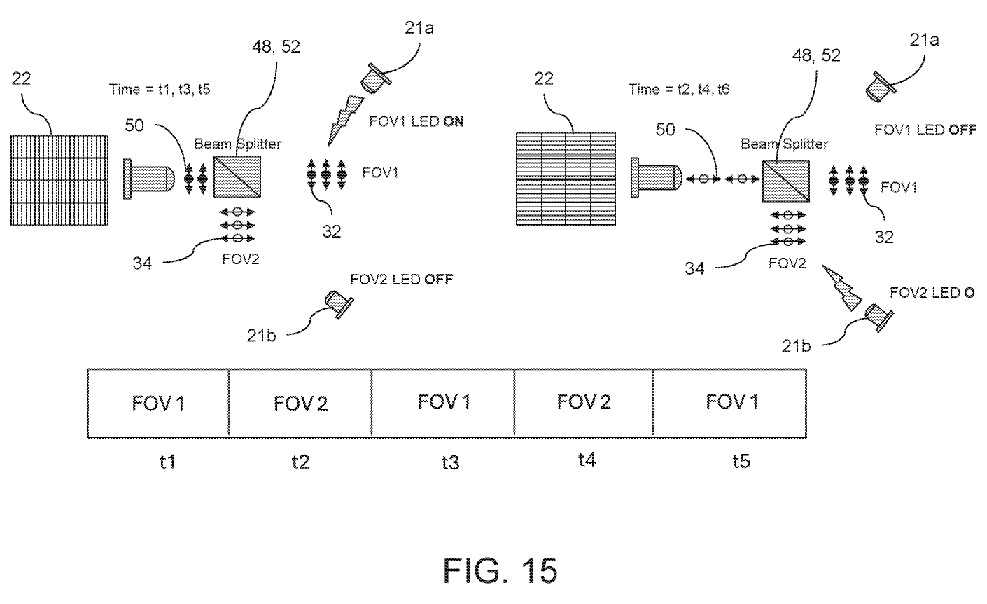

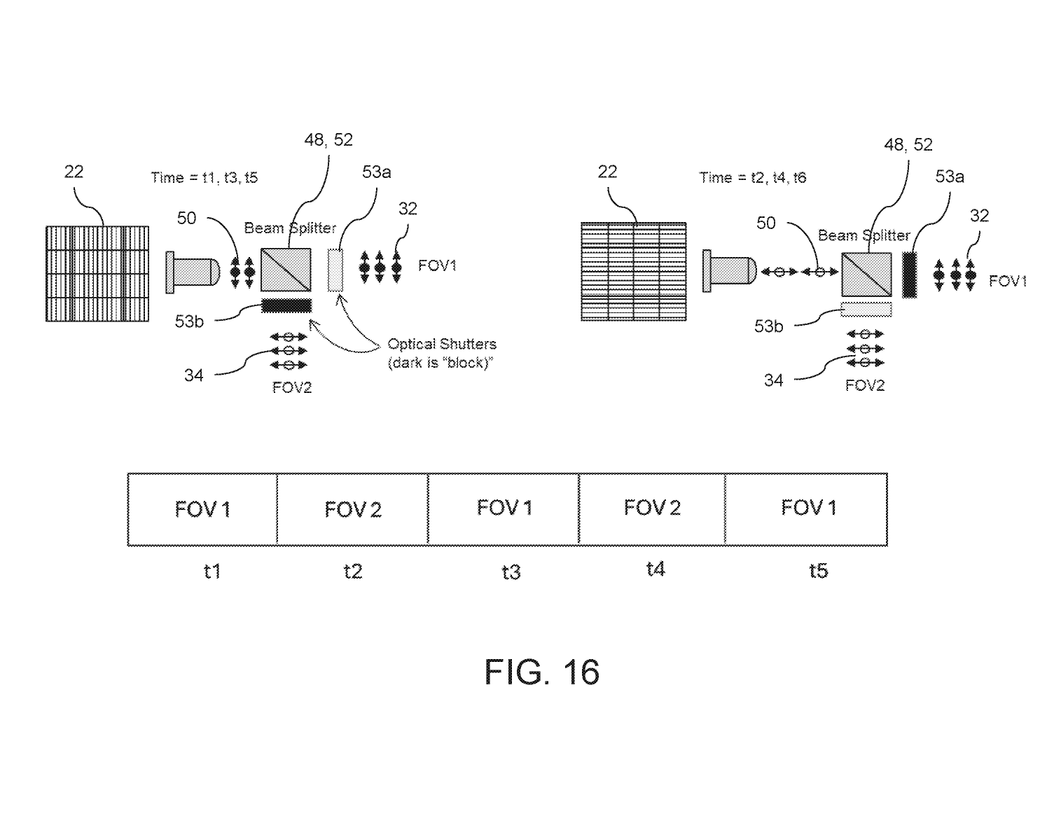

As shown in FIG. 15, a first near infrared light emitter 21a, such as disposed within the mirror head 12 of the interior rearview mirror assembly 10 of the vehicle, and with the interior rearview mirror assembly 10 mounted at the interior portion of the interior cabin of the vehicle, is electrically operable to emit near infrared light to illuminate at least the first region 26 (such as a passenger seating region) of the interior cabin of the vehicle. Image data captured by the mirror-mounted camera 18 is representative of near infrared light reflected from surfaces within the first region 26 of the cabin of the vehicle. A second near infrared light emitter 21b, which may also be disposed within the mirror head 12 of the interior rearview mirror assembly 10, is electrically operable to emit near infrared light to illuminate at least the second region 28 (such as a front footwell or a dashboard or lap of the driver and/or lap of a front passenger seated in the vehicle) of the interior cabin of the vehicle. Image data captured by the camera 18 is representative of near infrared light reflected from surfaces within the second region 28 of the cabin of the vehicle. When operated, the first near infrared light emitter 21a emits near infrared light with a first time cadence (e.g., at t1, t3, and t5 in FIG. 15) and the second near infrared light emitter 21b emits near infrared light with a second time cadence (at t2 and t4 in FIG. 15) different from the first time cadence. The first time cadence is larger than the second time cadence. That is, t1, t3, and t5 may span longer periods of time than t2 and t4. Image data representative of the first region 26 is captured by the camera 18 during the first time cadence and image data representative of the second region 28 is captured by the camera 18 during the second time cadence. Optionally, the first near infrared light emitter 21 a emits near infrared light at a first wavelength and the second near infrared light emitter 21 b emits near infrared light at a second wavelength different from the first wavelength, and the first region 26 of the interior cabin of the vehicle is illuminated with near infrared light at the first wavelength and the second region 28 is illuminated with near infrared light at the second wavelength.

Put another way, FIG. 15 illustrates that at time t1, the first LED 21 a illuminating the first region 26 is on while the second LED 21 b illuminating the second region 28 is off. At time t2, the second LED 21 b illuminating the second region 28 is on while the first LED 21a illuminating the first region 26 is off. Therefore, the LEDs illuminate alternatingly, and may be synchronized with the video capture frame rate. Optionally, the LEDs illuminate in unequal intervals from the video capture frame rate so that a higher proportion of frames are captured viewing the first region 26 as compared to the second region 28. While the beam splitter 52 combines both fields of view, the imager 18 captures only the field of view corresponding to the LED that is on, effectively switching and separating between the primary and secondary fields of view.

Optionally, a glass or lens or similar optic may direct light representative of one or more regions of the vehicle 11 toward the camera 18. An electric current may be applied to the glass to adjust its refractive index, thereby deviating the path from the original field of view. For example, with the camera 18 viewing through the mirror reflective element 14, a portion of the mirror reflective element 14 may be electrically charged to adjust the portion of the interior cabin of the vehicle 11 viewed by the camera 18 through the mirror reflective element 14.

Referring to FIG. 16, respective optical shutters (e.g. such as liquid crystal based shutters) alternatively switch to block the respective fields of view and view the respective fields of view. The imager 22 of the camera 18 captures image data from within the field of view which is not blocked by the optical shutter. In other words, a first optical shutter 53a is disposed in the first field of view so that light 32 representative of the first region 26 passes through the first optical shutter 53a to be incident at the beam splitter 52. A second optical shutter 53b is disposed in the second field of view so that light 34 representative of the second region 28 passes through the second optical shutter 53b to be incident at the beam splitter 52. Each optical shutter 53a, 53b may be adjustable or operable between a dimmed or darkened or blocking state and an at least partially transparent or non-blocking state. With the optical shutter in the blocking state, light does not pass through to be incident at the beam splitter 52 and with the optical shutter in the non-blocking state, light passes through to be incident at the beam splitter 52. Thus, the optical shutters 53a, 53b may be operated in an alternating fashion so that the camera 18 views one of the first region 26 and the second region 28 at a time.

FIG. 16 illustrates that at time t1, the first optical shutter 53a is in the non- blocking state so that the imager 22 views the first region 26 while the second optical shutter 53b is in the blocking state. At time t2, the second optical shutter 53b is in the non- blocking state so that the imager 22 views the second region 28 while the first optical shutter 53a is in the blocking state. Therefore, the shutters operate between the blocking and non-blocking states alternatingly, and may be synchronized with the video capture frame rate. Optionally, the shutters operate between the blocking and non-blocking state in unequal intervals from the video capture frame rate so that a higher proportion of frames are captured viewing the first region 26 as compared to the second region 28.

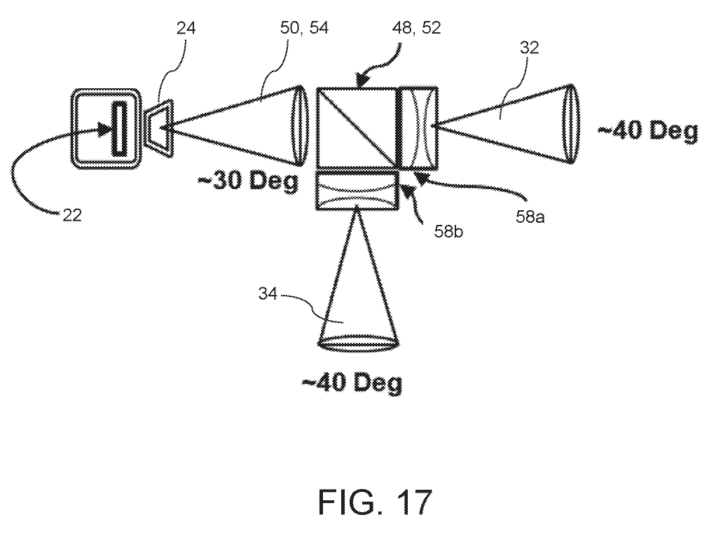

Referring to FIG. 17, in some examples, the mirror assembly 10 may include a first lens or first negative lens 58a configured to transmit and/or direct the light 32 representative of the first region 26 toward a partially transparent optic 48 and/or a polarizing beam splitter 52 and a second lens or second negative lens 58b configured to transmit and/or direct the light 34 representative of the second region 28 toward the optic 48, 52. The negative lenses 58a, 58b may comprise negative lenses (e.g., achromatic doublets) configured to transmit and/or direct incident light or images toward the optic 48, 52 with widened fields of view. For example, each negative lens 58a, 58b may direct light toward the imager 22 to provide a respective field of view with a width of up to about 40 degrees or wider, 60 degrees or wider and the like, with the primary viewing axes of the negative lenses 58a, 58b directed in different directions from one another to view the first region 26 and the second region 28. The optic 48, 52 may direct the combined light and/or combined image 50, 54 through the lens 24 to the imager 22. Optionally, the optic 48, 52 may be a cube-type beam splitter with dimensions of approximately ten millimeters by ten millimeters. In some examples, the lens 24 is a narrow lens (e.g., a telephoto lens). Optionally, the narrow lens has a field of view of approximately 10 degrees, approximately 20 degrees, approximately 30 degrees, approximately 40 degrees, etc.

The camera at the mirror assembly 10 including the negative lenses 58a, 58b may be configured to receive or image visible light, near-infrared light, and/or infrared light. In examples where at least one region of the interior cabin of the vehicle 11 is illuminated by near infrared light or by infrared light, one or more of the lenses 58a, 58b may be optimized for near-infrared and/or infrared imaging (e.g., using 940 nanometer near- infrared light). Additionally or alternatively, one respective lens 58a, 58b may be configured for transmitting and/or directing visible light, near-infrared light, and/or infrared light, and the other respective lens 58a, 58b may support red-green-blue-infrared imaging (RGB-IR imaging). That is, one lens 58a, 58b may be configured to transmit and/or direct visible light and infrared light, and the other lens 58a, 58b may be configured to transmit and/or direct infrared light.

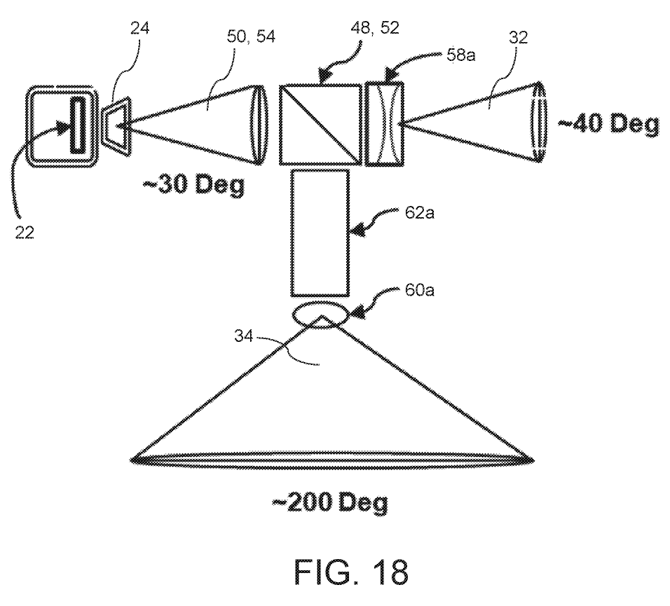

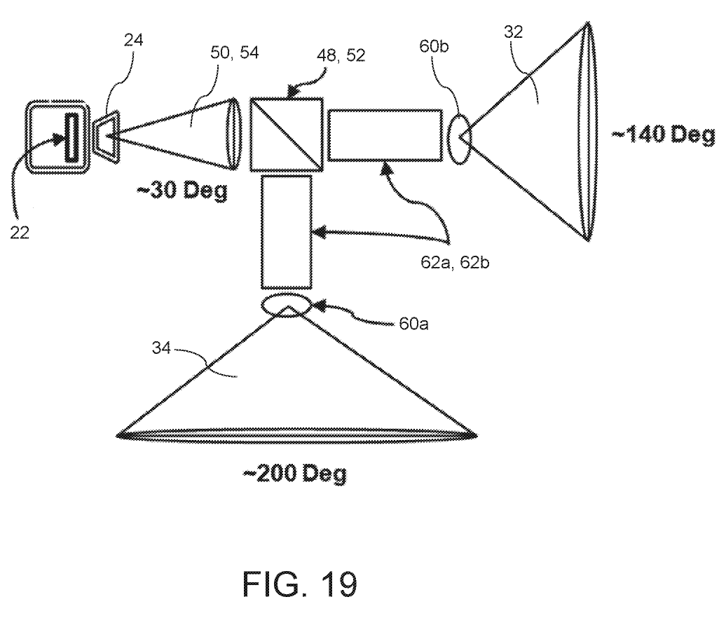

Referring now to FIGS. 18 and 19, the mirror assembly 10 may include one or more fisheye lenses configured to transmit and/or direct incident light or images toward the optic 48, 52 with widened fields of view. For example, the mirror assembly 10 may include a first fisheye lens 60a with a primary viewing axis configured to transmit and/or direct the light 34 representative of the second region 28 toward the optic 48, 52 (FIG. 18). Additional optical elements may also be included to compensate for the physical separation between the first fisheye lens 60a and the imager 22. For example, an optical relay 62a may be positioned between the first fisheye lens 60a and the optic 48, 52. The optical relay 62a includes one or more lenses that receive the image from the first fisheye lens 60a and direct the image to the optic 48, 52. The optical relay 62a may be a non-imaging, infinity- conjugate-to-infinity-conjugate relay, such that the first fisheye lens 60a and the optical relay 62a may have a field of view with a width of up to about 140 degrees or wider, 200 degrees or wider, and the like. Accordingly, the first fisheye lens 60a and the optical relay 62a may increase the light 34 representative of the second region 28 directed to the optic 48, 52, increasing the portion of the passenger seating region and/or the steering wheel region that is viewable by the imager 22.

In some examples, the mirror assembly 10 may include a second fisheye lens 60b with a primary viewing axis configured to transmit and/or direct light 32 representative of the first region 26 toward the optic 48, 52 (FIG. 19). A second optical relay 62b may be positioned between the second fisheye lens 60b and the optic 48, 52. The second optical relay 62b may be a non-imaging, infinity-conjugate-to-infinity-conjugate relay, such that the second fisheye lens 60b and the second optical relay 62b may have a field of view with a width of up to about 140 degrees or wider, 200 degrees or wider, and the like. Accordingly, the second fisheye lens 60b and the second optical relay 62b may increase the light 32 representative of the first region 26 directed to the optic 48, 52, increasing the portion of the driver's head region that is viewable by the imager 22.

The camera at the mirror assembly 10 including the first fisheye lens 60a and/or the second fisheye lens 60b may be configured to receive or image visible light, near- infrared light, and/or infrared light. In examples where at least one region of the interior cabin of the vehicle 11 is illuminated by near infrared light or by infrared light, the one or more lenses 60a, 60b may be optimized for near-infrared and/or infrared imaging (e.g., using 940 nanometer near-infrared light). Additionally or alternatively, one respective lens 60a, 60b may be configured for transmitting and/or directing visible light, near-infrared light, and/or infrared light, and the other respective lens 60a, 60b may support RGB-IR imaging. That is, one lens 60a, 60b may be configured to transmit and/or direct visible light and infrared light, and the other lens 60a, 60b may be configured to transmit and/or direct infrared light.

Thus, the mirror assembly and DMS/OMS provides an optical system employing a beam splitter and optical relays to achieve wide field-of-view imaging in both transmitted and reflected optical paths to simultaneously view the driver as well as occupants or the interior cabin of a vehicle. Systems utilizing beam splitters alone may be limited in their achievable field of view due to the planar nature of the beam splitter surfaces and the constraints imposed by the primary imaging lens. Employing narrow field-of-view lenses may maximize the amount of light entering the beam splitter, but this restricts the overall field of view of the system. The field of view may be expanded using negative lenses, such as up to about 40 degrees or wider. Because wider fields of view are needed in vehicular imaging, fisheye lenses may be integrated, with the physical separation between the fisheye lens and the imaging sensor solved via additional optical elements like optical relays.

For example, the one or more wide field-of-view lenses (e.g., fisheye or negative lenses) are configured to transmit or direct incident light or image information from regions within the interior cabin of the vehicle, with fields of view up to about 140 degrees or wider, 200 degrees or wider, and the like. Light from these lenses is directed along separate optical paths (transmitted and reflected) and then combined at the beam splitter. This beam splitter may be a cube type beam splitter with dimensions of approximately 10 millimeters by 10 millimeters. The combined light exiting the beam splitter then passes through the narrow primary lens (e.g., having a field of view of about 30 degrees) and directed onto the imaging sensor.

As shown in FIG. 17, the negative lenses positioned in both the transmitted and reflected optical paths may expand the field of view to approximately 40 degrees or wider in each path.

As shown in FIGS. 18 and 19, incorporating the optical relay system with fisheye lenses into both the transmitted and reflected paths may enable a field of view of up to 140 degrees or wider (e.g., in the transmitted path), up to 200 degrees or wider (e.g., in the reflected path), and the like. Optionally, the negative lens may be maintained in the transmission path with the optical relay system positioned in the reflected path. The optical relay system may be configured as a non-imaging, infinity-conjugate-to-infinity conjugate relay.

According to one aspect of the disclosure, an optical imaging system includes a first lens configured to receive incident light from a first field of view. A second lens is configured to receive incident light from a second field of view. The first and second fields of view are spatially distinct and at least one of the fields of view is wide (e.g., is greater than about 100 degrees). A beam splitter is optically coupled to the first lens and the second lens. The beam splitter is configured to combine light received from the first and second lenses into a common path. A primary lens is positioned in the common optical path and configured to focus the combined light. An imaging sensor is positioned to receive the focused, combined light from the primary lens.

Optionally, the first lens includes a fisheye lens. In some examples, at least one of the first or second lenses includes a negative lens configured to expand the field of view. Further, the beam splitter may be a cube beam splitter including a polarized beam splitter. Optionally, the system includes an optical relay positioned in at least one of the optical paths between the first or second lens and the beam splitter. The optical relay is configured as a non-imaging, infinity-conjugate-to-infinity-conjugate relay. The imaging sensor may be configured to operate in the visible spectrum and/or configured to operate in the near-infrared spectrum.

The first field of view may be approximately wide (e.g., 140 degrees) and the second field of view may be very wide (e.g., approximately 200 degrees). The first lens may be configured to collect visible and infrared light, and the second lens is optimized to collect infrared light only. Optionally, the primary lens has a very narrow field of view of approximately 10 degrees to 30 degrees.

Thus, the front passenger monitoring system for vehicles utilizes the same camera 18 used for driver monitoring, enhanced with a prism or mirror or polarizing optic to deflect light and extend the field of view simultaneously or by rapid switching between viewing angles. This allows the system to monitor both the driver and the front passenger using a single imaging device. The system may recognize dangerous positions of the front passenger, such as being too close to the airbag or having legs on the dashboard. Optionally, it may also extend the field of view to cover more of the driver's hand positions. The image signal processing is performed either independently on data from each available viewing angle or on a superposition of each viewing angle in one image. Al algorithms may be applied individually or collectively on each of the fields of view. For example, with the system detecting portions of the driver and portions of the passenger, the system may apply Al algorithms to make more informed decisions based on more complete information.

The wide angle lenses, such as fisheye or negative lenses, feed light into both the transmitted and reflected paths of the beam splitter. Each path may include a non-imaging optical relay that re-images the wide-angle input, ensuring that both beams are properly conditioned before recombination. The beam splitter simultaneously directs and combines these transmitted and reflected optical paths into a common axis, which may then be passed through a narrow primary lens. The primary lens focuses the merged beams onto a single imager, enabling fields of view of approximately 140 degrees or more in the transmitted path and up to 200 degrees or more in the reflected path. The system supports operation in both visible and near infrared ranges. For example, one path may be optimized for infrared-only monitoring and the other path may support RGB-IR imaging. This provides comprehensive driver, passenger, and cabin coverage using a single camera module. The system uses a cube beam splitter combined with optical relays to merge ultra-wide asymmetric fields of view (e.g., about 140 degrees in the transmitted path, about 200 degrees in the reflected path) into a single sensor system with dual spectral specialization (e.g., RGB-IR and IR-only), thereby enabling comprehensive monitoring in a compact module.

Camera-based driver monitoring requires that the likes of eye movement / gaze direction / head orientation of the driver of the vehicle be continually monitored, basically at a blink-of-an-eye rate. Cabin monitoring requires the camera to view regions within the cabin of the vehicle, such as a front seat region and/or a second row rear seating region and/or a third row rear seating region, for monitoring at a lower sampling rate. However, seat occupancy regions and/or the likes of legs of occupants viewing is complex and the camera's view can be occluded by seat backs and seats and other interior cabin structures. For front seat occupants (including the driver), for example, the system may monitor how the front passenger is seated or oriented at the front passenger seat. For example, the system may monitor whether the legs of the front passenger are oriented or positioned in a way that corresponds to a properly seated and secured position of the front passenger at the passenger seat with a seatbelt secured. Thus, it is desirable that the camera, while operating in such an occupant monitoring mode, views downward into the front seating region where passenger's legs and/or driver's legs are present.

Conventionally, the challenge of high resolution monitoring of the driver's eyes while concomitantly performing occupant monitoring throughout the cabin of the vehicle is met by using at least two cameras, typically a driver monitoring camera located at, for example, a steering column of the vehicle, and directed at and having a field of view that is narrowed to include and focus on the driver's eyes, and a second separate camera (typically high-mounted, such as at a header or roof region of the vehicle) that views downward and performs the occupant monitoring function. Such systems can be complex and costly.

The vehicular cabin monitoring system described herein utilizes a single common megapixel camera (e.g., a high-resolution vehicular camera utilizing an imaging array having at least one million pixels, such as at least three megapixels, at least five megapixels, at least eight megapixels, and the like) used in conjunction with an optical element that, via refraction and/or total internal reflection, singly performs what previously required a plurality of cameras. Thus, image processing at an image processor distinguishes at least two distinct regions of the vehicle, such as the driver-eye region within the cabin of the vehicle and the foot well region in front of, for example, the driver seat and/or front passenger seat of the vehicle. The image processor operates to process driver's eye region data in the frames of image data captured by the single camera for a driver monitoring function and operates to process foot well region data in the frames of image data captured by the single camera for occupant monitoring.

Euro NCAP (https://www.euroncap.com/en/about-euro-ncap/) rates vehicles in Europe against a five-star safety rating system to help consumers, their families and businesses compare vehicles more easily and to help them identify the safest choice for their needs. Euro NCAP 28 will apply after 2028. After 2028, posture-robust occupant monitoring will be an important requirement for 5-star vehicles. Poor (and potentially unsafe) posture can comprise likes of a torso significantly forward of a seatback, a head close to the instrument panel in the vehicle's interior cabin or in an airbag zone, a seatbelt visible and used but with its geometry altered/ill-positioned. For the driver and/or the front seat passenger, leg posture that degrades seat belt routing, torso reference or seat occupancy can impact NCAP scoring. The front passenger's feet being on the dashboard is a particularly unsafe posture. Wide knee spread by the front passenger and seat-edge perching by the driver are further examples of poor posture. The dual-field of view innovations of the cabin monitoring system allow a single mirror-mounted camera to primarily view out from the mirror head of the interior rearview mirror assembly of the equipped vehicle into the interior cabin of the vehicle (such as covert behind and viewing through the mirror reflective element of the interior rearview mirror assembly) to monitor the driver and front and rear passenger(s) seated in the cabin and at the same time, secondarily view downward (not necessarily through the mirror element) to view the top of the dashboard and into the footwell in front of the driver/front passenger seating so as to detect posture of the driver's and/or front passenger's legs/knees/feet.

Thus, vehicles have long been equipped with sensors such as cameras, radars, and lidars to monitor both the environment outside of the vehicle and the interior of the vehicle. Despite having multiple sensors, blind spots exist outside the respective sensors' field of view. For Driver Monitoring Systems (DMS) and Occupant Monitoring Systems (OMS), a camera can be positioned at the interior rearview mirror assembly, with its field of view (field of view) principally directed towards the driver's eye/head and encompassing at least the front passenger seat region of the equipped vehicle. The lens of this camera can view through the mirror reflective element (and do so covertly by viewing through a transflector of the mirror reflective element) or the lens of the camera can view directly into the front and rear seating regions of the interior cabin and not through a transflector of the mirror reflective element.

Use of an optical element (such as a beam splitter as disclosed herein) allows the imager 22 of the single camera 18 located in the mirror housing/casing of the mirror head of the interior rearview mirror assembly 10 to have a bifurcated dual field of view. That is, the camera 18 views a first field of view including the first region 26 (e.g., generally outward from the interior rearview mirror assembly and rearward toward the rear of the vehicle) into the cabin of the vehicle, such as to monitor not only the eyes/head of the driver but also to monitor passengers seated in front and/or rear seats within the interior cabin of the equipped vehicle. The camera 18 also views a second field of view including the second region 28 (such as the front footwell or the dashboard etc.) that may be below and forward (toward the front of the vehicle) of the mirror housing/casing of the mirror head of the interior rearview mirror assembly that is mounted at a central upper region of the windshield (or mounted at a header region) of the equipped vehicle. Monitoring of the eyes/head of the driver within the first field of view (for likes of driver distraction, driver impairment, driver drowsiness, driver gaze direction, driver attentiveness, etc.) utilizes rapid processing of image data captured by the imager of the camera 18 (e.g., for a camera capturing frames of data at 60 frames per second, sampling every 15 milliseconds or so is possible). Monitoring of likes of feet posture in a front footwell may not utilize as rapid of image processing, such that sampling within the second field of view may be at a sampling rate with a period of hundreds rather than tens of milliseconds.

Use of electro-optical shutters and/or differential operation of near infrared illumination of the respective regions within the first and second fields of view may allow the imager 22 of the single cabin monitoring camera 18 used to process image data representative of what is occurring in the first region of the interior cabin (such as the front and rear seating regions with interior cabin) without needing to process image data representative of what is occurring in the second region of the interior cabin (such as the footwell region below the mirror head of the interior rearview mirror assembly), and vice versa. Further, the camera 18 may be covertly mounted in the mirror head behind the mirror reflective element 14 with the first field of view of the camera 18 through (and thus having light intensity attenuated by) a transflector of the mirror reflective element 14. The second field of view of the camera 18 may be downward and not pass through (and thus not have light intensity attenuated by) the transflector of the mirror reflective element 14. That is, the second field of view of the camera 18 may view downward, such as via an opening/lens in the bottom of the mirror housing/casing of the mirror head of the interior rearview mirror assembly.

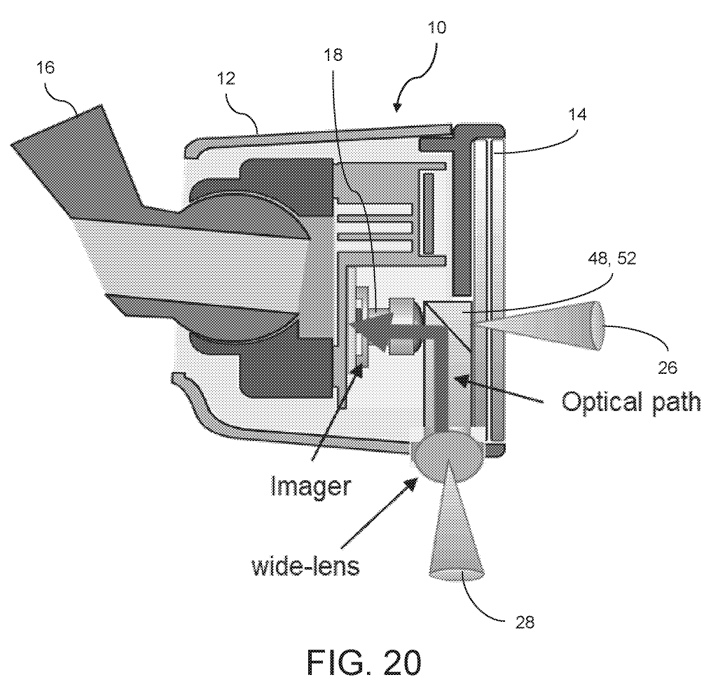

As can be seen in FIG. 20, one of the challenges of using the beam splitter 52 inside of the mirror housing/casing of the mirror head of the interior rearview mirror assembly 10 is that the optical path traveled from the wide-field of view lens at the bottom region of the mirror housing/casing to the imager 22 can be large. This can result in a blurred image or tunnel vision.

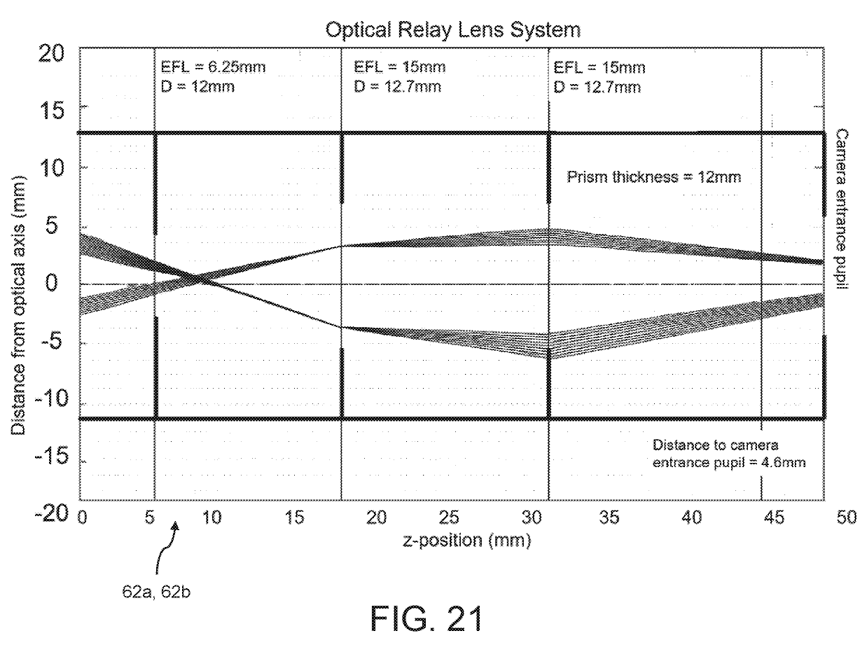

The driver monitoring system solves this by using an optical relay system 62a, 62b (shown in FIG. 21) that transfers the image from the wide-field of view lens closer to the camera 18. The optical relay system 62a, 62b consists of a sequence of lenses such that the exit pupil of the beam splitter / wide-lens optical system matches the entrance pupil of the camera lens. This optical element enables the imager 22 to be positioned farther from the lens. Further, the optical relay 62a, 62b allows the system to accommodate a beam splitter and/or other lenses within the optical path of the camera 18 and ensures that the system fits properly within the mirror housing/casing of the mirror head of the interior rearview mirror assembly.

The camera and driver monitoring system may utilize characteristics of the cameras and vehicular vision systems described in U.S. Pat. Pub. No. US-2025-0256650, which is hereby incorporated herein by reference in its entirety.

The camera or sensor may comprise any suitable camera or sensor. Optionally, the camera may comprise a "smart camera" that includes the imaging sensor array and associated circuitry and image processing circuitry and electrical connectors and the like as part of a camera module, such as by utilizing aspects of the vision systems described in U.S. Pat. Nos. 10,099,614 and/or 10,071,687, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor of the camera may capture image data for image processing and may comprise, for example, a two dimensional array of a plurality of photosensor elements arranged in at least 640 columns and 480 rows (at least a 640 x 480 imaging array, such as a megapixel imaging array or the like), with a lens focusing images onto the imaging array. The photosensor array may comprise a plurality of photosensor elements arranged in a photosensor array having rows and columns. The imaging array may comprise a CMOS imaging array having at least 300,000 photosensor elements or pixels, preferably at least 500,000 photosensor elements or pixels and more preferably at least one million photosensor elements or at least two million photosensor elements or pixels or at least three million photosensor elements or pixels or at least five million photosensor elements or pixels or at least eight million photosensor elements or pixels arranged in rows and columns. The imaging array may be sensitive to near-infrared light. The imaging array may capture color image data, such as via spectral filtering at the array, such as via an RGB (red, green and blue) filter or via a red / red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 9,233,641; 9,146,898; 9,174,574; 9,090,234; 9,077,098; 8,818,042; 8,886,401; 9,077,962; 9,068,390; 9,140,789; 9,092,986; 9,205,776; 8,917,169; 8,694,224; 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or U.S. Publication Nos. US-2014-0340510; US-2014-0313339; US-2014- 0347486; US-2014-0320658; US-2014-0336876; US-2014-0307095; US-2014-0327774; US-2014-0327772; US-2014-0320636; US-2014-0293057; US-2014-0309884; US-2014- 0226012; US-2014-0293042; US-2014-0218535; US-2014-0218535; US-2014-0247354; US-2014-0247355; US-2014-0247352; US-2014-0232869; US-201 4-0211009; US-2014- 0160276; US-2014-0168437; US-2014-0168415; US-2014-0160291; US-2014-0152825; US-2014-0139676; US-2014-0138140; US-2014-0104426; US-2014-0098229; US-2014- 0085472; US-2014-0067206; US-2014-0049646; US-2014-0052340; US-2014-0025240; US-2014-0028852; US-2014-005907; US-2013-0314503; US-2013-0298866; US-2013- 0222593; US-2013-0300869; US-2013-0278769; US-2013-0258077; US-2013-0258077; US-2013-0242099; US-2013-0215271; US-2013-0141578 and/or US-2013-0002873, which are all hereby incorporated herein by reference in their entireties. The system may communicate with other communication systems via any suitable means, such as by utilizing aspects of the systems described in U.S. Pat. Nos. 10,071,687; 9,900,490; 9,126,525 and/or 9,036,026, which are hereby incorporated herein by reference in their entireties.

The system may utilize aspects of driver monitoring systems and/or head and face direction and position tracking systems and/or eye tracking systems and/or gesture recognition systems. Such head and face direction and/or position tracking systems and/or eye tracking systems and/or gesture recognition systems may utilize aspects of the systems described in U.S. Pat. Nos. 11,827,153; 11,780,372; 11,639,134; 11,582,425; 11,518,401; 10,958,830; 10,065,574; 10,017,114; 9,405,120 and/or 7,914,187, and/or U.S. Publication Nos. US-2025-0329174; US-2024-0383406; US-2024-0190456; US-2024- 0168355; US-2022-0377219; US-2022-0254132; US-2022-0242438; US-2021-0323473; US-2021-0291739; US-2020-0320320; US-2020-0202151; US-2020-0143560; US-2019- 0210615; US-2018-0231976; US-2018-0222414; US-2017-0274906; US-2017-0217367; US-2016-0209647; US-2016-0137126; US-2015-0352953; US-2015-0296135; US-2015- 0294169; US-2015-0232030; US-2015-0092042; US-2015-0022664; US-2015-0015710; US-2015-0009010 and/or US-2014-0336876, and/or International Publication Nos. WO 2026/019985 and/or WO 2025/231198, which are all hereby incorporated herein by reference in their entireties.

The interior-viewing camera may be disposed at the mirror head of the interior rearview mirror assembly and moves together and in tandem with the mirror head when the driver of the vehicle adjusts the mirror head to adjust his or her rearward view. The interior-viewing camera may be disposed at a lower or chin region of the mirror head below the mirror reflective element of the mirror head, or the interior-viewing camera may be disposed behind the mirror reflective element and viewing through the mirror reflective element. Similarly, the light emitter may be disposed at the lower or chin region of the mirror head below the mirror reflective element of the mirror head (such as to one side or the other of the interior-viewing camera), or the light emitter may be disposed behind the mirror reflective element and emitting light that passes through the mirror reflective element. The ECU may be disposed at the mirror assembly (such as accommodated by the mirror head), or the ECU may be disposed elsewhere in the vehicle remote from the mirror assembly, whereby image data captured by the interior-viewing camera may be transferred to the ECU via a coaxial cable or other suitable communication line. Cabin monitoring or occupant detection may be achieved via processing at the ECU of image data captured by the interior-viewing camera. Optionally, cabin monitoring or occupant detection may be achieved in part via processing at the ECU of radar data captured by one or more interior-sensing radar sensors disposed within the vehicle (including at the interior rearview mirror assembly) and sensing the interior cabin of the vehicle.

The coaxial cable may provide bi-directional communication between the mirror head and the ECU, which may be located at the vehicle remote from the mirror head. For example, the coaxial cable may provide power from the ECU to the mirror head and may provide control signals or data to the mirror head and may carry image data from the camera at the mirror head to the ECU that can be located in the vehicle separate and distant from the location in the interior cabin of the vehicle where the interior mirror assembly that accommodates the camera is located (the interior rearview mirror assembly typically is centrally mounted at an upper in-cabin side of the vehicle's windshield). The coaxial cable and electronic connection between the ECU and the mirror head may utilize aspects of the systems described in U.S. Pat. Nos. 10,567,705; 10,298,823; 10,099,614; 10,089,537; 9,900,490 and/or 9,609,757, which are hereby incorporated herein by reference in their entireties. Thus, the bi-directional coaxial cable may commonly carry (i) image data captured by the camera from the mirror head to the ECU, (ii) control signals from the ECU to the mirror head (such as for controlling the camera and/or a light emitter and/or dimming circuitry of the mirror head), and (iii) electrical power from a DC power supply of (or connected to) the ECU to the mirror head.

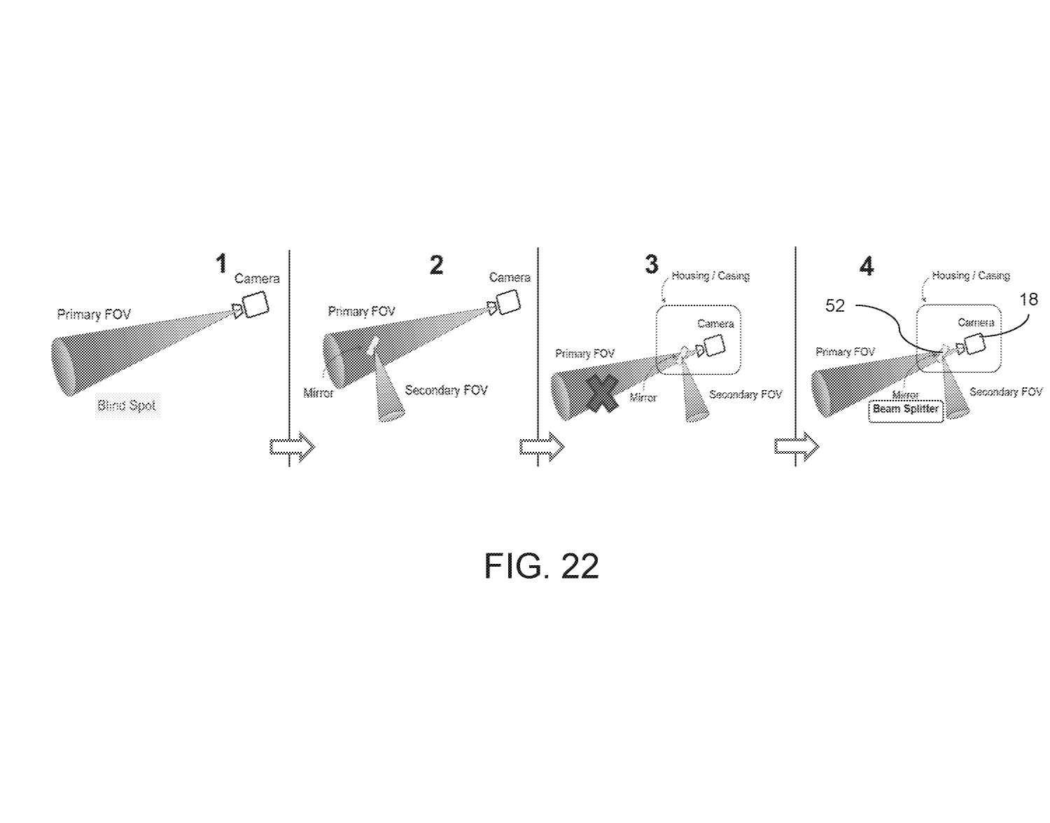

Referring to FIG. 22, a single camera may have a main field of view, with a blind spot existing outside of the field of view. A reflective optic, such as a mirror or prism, may be placed within the field of view of the camera to redirect part of the optical path to view into a blind spot. However, this may create the issue that the mirror is positioned too far from the camera, preventing integration into a single compact system. Bringing the reflective optic closer to the camera blocks the camera from viewing at least a portion of the primary field of view. By contrast, the beam splitter 52 enables simultaneous reflection and transmission of light, and thus enables the camera 18 to view simultaneous primary and secondary fields of view. The primary and secondary fields of view may be separately viewed and/or processed, as discussed herein.

For example, a non-polarized beam splitter may be disposed in the primary field of view of the camera 18 and one or more illuminators (having a visible light source or an infrared or near infrared light source) may be operated to illuminate the first region 26 or the second region 28. Further, a non-polarized beam splitter may be disposed in the primary field of view of the camera 18 with optical shutters 53a, 53b used to block the first region 26 or the second region 28. Optionally, a polarized beam splitter may be disposed in the primary field of view of the camera 18 with a polarization modulator or selector 56 operated so that the camera 18 views the first region 26 or the second region 28. In some examples, a polarized beam splitter may be disposed in the primary field of view of the camera 18 with pixels of the imager 22 configured to capture image data representative of different polarized light to view the first region 26 and the second region 28.

The dual field of views using the single mirror-mounted camera may optionally partially (but not wholly) overlap, thus capturing same common data points for image processing from two views and so allowing extraction of depth information or achievement of better holistic detections or improved calibration. Notwithstanding partial overlap in fields of view, the two regions of the interior cabin of the equipped are distinct and different from one another. The occupant monitoring system is not just for occupants but also for driver hands, monitoring the dashboard (for advance phone usage), and monitoring the footwell area. Use of optical lens relays help overcome challenging mechanical constraints such as integration inside of an already crowded mirror housing/casing of the mirror head of a vehicular interior rearview mirror assembly.

Though exemplified herein with the camera mounted in an interior rearview mirror assembly, use of an optical element (such as a beam splitter), may enable a single driver/occupant-monitoring camera that is installed and used in a vehicle other than at an interior rearview mirror (such as at a steering column of an equipped vehicle or at a facia/instrument panel of an equipped vehicle or at a header/headliner/roof/overhead console/grab handle of an equipped vehicle) to have a dual-field of view and view into two distinct regions of the interior cabin of an equipped vehicle.

According to an aspect of the disclosure, a vehicular cabin monitoring system includes an interior rearview mirror assembly including a mirror head adjustable about a mounting structure. The mounting structure is configured to mount the interior rearview mirror assembly at an interior portion of an interior cabin of a vehicle. The mirror head accommodates a mirror reflective element and an optical element. A camera is accommodated by the mirror head. With the interior rearview mirror assembly mounted at the interior portion of the interior cabin of the vehicle, the camera views within the interior cabin of the vehicle. The camera viewing within the interior cabin of the vehicle has a first field of view and a second field of view. A first region within the interior cabin of the vehicle is within the first field of view of the camera, and a second region within the interior cabin of the vehicle is within the second field of view of the camera. The second region of the interior cabin of the vehicle is different from the first region of the interior cabin of the vehicle. At least one selected of (i) the camera views the first region within the interior cabin of the vehicle via the optical element and (ii) the camera views the second region within the interior cabin of the vehicle via the optical element. The camera and the mirror reflective element move together and in tandem with the mirror head when, with the interior rearview mirror assembly mounted at the interior portion of the interior cabin of the vehicle, the mirror head is adjusted about the mounting structure to provide a rearward view for a driver of the vehicle viewing the mirror reflective element. Image data captured by the camera is transferred to an ECU of the system. The ECU includes electronic circuitry and associated software. The electronic circuitry of the ECU includes an image processor operable to process image data transferred to the ECU. With the interior rearview mirror assembly mounted at the interior portion of the interior cabin of the vehicle, (i) image data captured by the camera and representative of the first region is processed at the ECU for monitoring at least the driver of the vehicle and (ii) image data captured by the camera and representative of the second region is processed at the ECU for monitoring at least a passenger region within the interior cabin of the vehicle. Aspects of the disclosure may include one or more of the following optional features.

In some implementations, the camera views the first region within the interior cabin of the vehicle via the optical element, and the camera views the second region within the interior cabin of the vehicle via the optical element. The optical element includes a beam splitter.

In some examples, light that passes through an aperture in the mirror head is redirected via the optical element toward the camera.

In some aspects, with the interior rearview mirror assembly mounted at the interior portion of the interior cabin of the vehicle, image data captured by the camera and representative of the second region is processed at the ECU for monitoring a front footwell region within the interior cabin of the vehicle

In some implementations, the camera views the first region within the interior cabin of the vehicle through the mirror reflective element. The camera views the second region within the interior cabin of the vehicle via the optical element.

In some examples, the camera views the first region within the interior cabin of the vehicle via the optical element. The camera views the second region within the interior cabin of the vehicle via the optical element. The optical element includes a cube polarizing beam splitter.

In some aspects, the optical element includes a beam splitter. The beam splitter directs light that is representative of the first region and incident at the mirror reflective element toward the camera. The beam splitter directs light that is representative of the second region and that passes through an aperture in the mirror head toward the camera. In further aspects, the beam splitter includes a polarizing beam splitter. The polarizing beam splitter directs light that is representative of the first region and having a first polarization state toward the camera. The polarizing beam splitter directs light that is representative of the second region and having a different second polarization state toward the camera. In even further aspects, the camera includes an imager. A polarization selector is disposed between the polarizing beam splitter and the imager. The polarization selector is operable between (i) a first state where light incident at the polarization selector and having the first polarization state passes through the polarization selector to be incident at the imager and light incident at the polarization selector and having the second polarization state does not pass through the polarization selector and (ii) a second state where light incident at the polarization selector and having the second polarization state passes through the polarization selector to be incident at the imager and light incident at the polarization selector and having the first polarization state does not pass through the polarization selector. With the polarization selector operating in the first state, the camera views the first region. With the polarization selector operating in the second state, the camera views the second region. In other even further aspects, the camera includes an imager. The imager includes (i) a first set of pixels that capture image data representative of light incident at the imager and having the first polarization state and (ii) a second set of pixels that capture image data representative of light incident at the imager and having the second polarization state. In other further aspects, the mirror head accommodates a first lens and a second lens. Light that is representative of the first region and that is incident at the mirror reflective element (i) passes through the first lens to be incident at the beam splitter and (ii) is directed by the beam splitter toward the camera. Light that is representative of the second region and that passes through the aperture in the mirror head (a) passes through the second lens to be incident at the beam splitter and (b) is directed by the beam splitter toward the camera. In even further aspects, The first lens and/or the second lens includes a negative lens having a field of view with a width of at least 40 degrees. In other even further aspects, the first lens and/or the second lens includes a fisheye lens. An optical relay is disposed between the fisheye lens and the beam splitter so that light transmitted by the fisheye lens is transmitted by the optical relay to be incident at the beam splitter.

In some implementations, a first near infrared light emitter is accommodated by the mirror head of the interior rearview mirror assembly. With the interior rearview mirror assembly mounted at the interior portion of the interior cabin of the vehicle, the first near infrared light emitter is electrically operable to emit near infrared light to illuminate at least the first region of the interior cabin of the vehicle. A first portion of image data captured by the camera is representative of near infrared light reflected from surfaces within the first region of the cabin of the vehicle. A second near infrared light emitter is accommodated by the mirror head of the interior rearview mirror assembly. With the interior rearview mirror assembly mounted at the interior portion of the interior cabin of the vehicle, the second near infrared light emitter is electrically operable to emit near infrared light to illuminate at least the second region of the interior cabin of the vehicle. A second portion of image data captured by the camera is representative of near infrared light reflected from surfaces within the second region of the cabin of the vehicle. In further implementations, the first near infrared light emitter emits near infrared light with a first time cadence and the second near infrared light emitter emits near infrared light with a second time cadence different from the first time cadence. The first portion of image data is captured by the camera during the first time cadence and the second portion of image data is captured by the camera during the second time cadence. In other further implementations, the first near infrared light emitter emits near infrared light at a first wavelength and the second near infrared light emitter emits near infrared light at a second wavelength different from the first wavelength. The first portion of image data is representative of near infrared light at the first wavelength and the second portion of image data is representative of near infrared light at the second wavelength.

According to another aspect of the disclosure, a vehicular cabin monitoring system includes an interior rearview mirror assembly including a mirror head adjustable about a mounting structure. The mounting structure is configured to mount the interior rearview mirror assembly at an interior portion of an interior cabin of a vehicle. The mirror head accommodates a mirror reflective element, a first lens and a second lens. A camera is accommodated by the mirror head. With the interior rearview mirror assembly mounted at the interior portion of the interior cabin of the vehicle, the camera views within the interior cabin of the vehicle. The camera viewing within the interior cabin of the vehicle has a first field of view and a second field of view. A first region within the interior cabin of the vehicle is within the first field of view of the camera. A second region within the interior cabin of the vehicle is within the second field of view of the camera. The second region of the interior cabin of the vehicle is different from the first region of the interior cabin of the vehicle. The camera views the first region within the interior cabin of the vehicle via the first lens. The camera views the second region within the interior cabin of the vehicle via the second lens. An optical element is accommodated by the mirror head. Light that is representative of the first region (i) passes through the first lens to be incident at the optical element and (ii) is directed by the optical element toward the camera. Light that is representative of the second region (a) passes through the second lens to be incident at the optical element and (b) is directed by the optical element toward the camera. At least one of the first lens and the second lens includes a negative lens having a field of view with a width of at least 40 degrees. The camera and the mirror reflective element move together and in tandem with the mirror head when, with the interior rearview mirror assembly mounted at the interior portion of the interior cabin of the vehicle, the mirror head is adjusted about the mounting structure to provide a rearward view for a driver of the vehicle viewing the mirror reflective element. Image data captured by the camera is transferred to an ECU of the system. The ECU includes electronic circuitry and associated software. The electronic circuitry of the ECU includes an image processor operable to process image data transferred to the ECU. With the interior rearview mirror assembly mounted at the interior portion of the interior cabin of the vehicle, (i) image data captured by the camera and representative of the first region is processed at the ECU for monitoring at least the driver of the vehicle and (ii) image data captured by the camera and representative of the second region is processed at the ECU for monitoring at least a passenger region within the interior cabin of the vehicle.

This aspect may include one or more of the following optional features. In some implementations, the camera views the first region within the interior cabin of the vehicle and the second region within the interior cabin of the vehicle through the mirror reflective element.

Yet another aspect of the disclosure provides a vehicular cabin monitoring system that includes an interior rearview mirror assembly including a mirror head adjustable about a mounting structure. The mounting structure is configured to mount the interior rearview mirror assembly at an interior portion of an interior cabin of a vehicle. The mirror head accommodates a mirror reflective element, a first lens and a second lens. A camera is accommodated by the mirror head. With the interior rearview mirror assembly mounted at the interior portion of the interior cabin of the vehicle, the camera views within the interior cabin of the vehicle. The camera viewing within the interior cabin of the vehicle has a first field of view and a second field of view. A first region within the interior cabin of the vehicle is within the first field of view of the camera. A second region within the interior cabin of the vehicle is within the second field of view of the camera. The second region of the interior cabin of the vehicle is different from the first region of the interior cabin of the vehicle. The camera views the first region within the interior cabin of the vehicle via the first lens. The camera views the second region within the interior cabin of the vehicle via the second lens. An optical element is accommodated by the mirror head. Light that is representative of the first region (i) passes through the first lens to be incident at the optical element and (ii) is directed by the optical element toward the camera. Light that is representative of the second region (a) passes through the second lens to be incident at the optical element and (b) is directed by the optical element toward the camera. At least one selected of the first lens and the second lens includes a fisheye lens. An optical relay is disposed between the fisheye lens and the optical element so that light transmitted by the fisheye lens is transmitted by the optical relay to be incident at the optical element. The camera and the mirror reflective element move together and in tandem with the mirror head when, with the interior rearview mirror assembly mounted at the interior portion of the interior cabin of the vehicle, the mirror head is adjusted about the mounting structure to provide a rearward view for a driver of the vehicle viewing the mirror reflective element. Image data captured by the camera is transferred to an ECU of the system. The ECU includes electronic circuitry and associated software. The electronic circuitry of the ECU includes an image processor operable to process image data transferred to the ECU. With the interior rearview mirror assembly mounted at the interior portion of the interior cabin of the vehicle, (i) image data captured by the camera and representative of the first region is processed at the ECU for monitoring at least the driver of the vehicle and (ii) image data captured by the camera and representative of the second region is processed at the ECU for monitoring at least a passenger region within the interior cabin of the vehicle.

This aspect may include one or more of the following optional features. In some implementations, the optical element includes a beam splitter. The beam splitter directs light that is representative of the first region and incident at the mirror reflective element toward the camera. The beam splitter directs light that is representative of the second region and that passes through an aperture in the mirror head toward the camera.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular cabin monitoring system, the vehicular cabin monitoring system comprising:an interior rearview mirror assembly comprises a mirror head adjustable about a mounting structure, wherein the mounting structure is configured to mount the interior rearview mirror assembly at an interior portion of an interior cabin of a vehicle;wherein the mirror head accommodates a mirror reflective element and an optical element;wherein a camera is accommodated by the mirror head, and wherein, with the interior rearview mirror assembly mounted at the interior portion of the interior cabin of the vehicle, the camera views within the interior cabin of the vehicle;wherein the camera viewing within the interior cabin of the vehicle has a first field of view and a second field of view;wherein a first region within the interior cabin of the vehicle is within the first field of view of the camera, and wherein a second region within the interior cabin of the vehicle is within the second field of view of the camera, and wherein the second region of the interior cabin of the vehicle is different from the first region of the interior cabin of the vehicle;wherein at least one selected from the group consisting of (i) the camera views the first region within the interior cabin of the vehicle via the optical element and (ii) the camera views the second region within the interior cabin of the vehicle via the optical element;wherein the camera and the mirror reflective element move together and in tandem with the mirror head when, with the interior rearview mirror assembly mounted at the interior portion of the interior cabin of the vehicle, the mirror head is adjusted about the mounting structure to provide a rearward view for a driver of the vehicle viewing the mirror reflective element;an electronic control unit (ECU);wherein image data captured by the camera is transferred to the ECU;wherein the ECU comprises electronic circuitry and associated software, and wherein the electronic circuitry of the ECU comprises an image processor operable to process image data transferred to the ECU; and
wherein, with the interior rearview mirror assembly mounted at the interior portion of the interior cabin of the vehicle, (i) image data captured by the camera and representative of the first region is processed at the ECU for monitoring at least the driver of the vehicle and (ii) image data captured by the camera and representative of the second region is processed at the ECU for monitoring at least a passenger region within the interior cabin of the vehicle.

2. The vehicular cabin monitoring system of claim 1, wherein the camera views the first region within the interior cabin of the vehicle via the optical element, and wherein the camera views the second region within the interior cabin of the vehicle via the optical element, and wherein the optical element comprises a beam splitter.

3. The vehicular cabin monitoring system of claim 1, wherein light that passes through an aperture in the mirror head is redirected via the optical element toward the camera.

4. The vehicular cabin monitoring system of claim 1, wherein, with the interior rearview mirror assembly mounted at the interior portion of the interior cabin of the vehicle, image data captured by the camera and representative of the second region is processed at the ECU for monitoring a front footwell region within the interior cabin of the vehicle.

5. The vehicular cabin monitoring system of claim 1, wherein the camera views the first region within the interior cabin of the vehicle through the mirror reflective element, and wherein the camera views the second region within the interior cabin of the vehicle via the optical element.

6. The vehicular cabin monitoring system of claim 1, wherein the camera views the first region within the interior cabin of the vehicle via the optical element, and wherein the camera views the second region within the interior cabin of the vehicle via the optical element, and wherein the optical element comprises a cube polarizing beam splitter.

7. The vehicular cabin monitoring system of claim 1, wherein the optical element comprises a beam splitter, and wherein (i) the beam splitter directs light that is 38
representative of the first region and incident at the mirror reflective element toward the camera and (ii) the beam splitter directs light that is representative of the second region and that passes through an aperture in the mirror head toward the camera.

8. The vehicular cabin monitoring system of claim 7, wherein the beam splitter comprises a polarizing beam splitter, and wherein (i) the polarizing beam splitter directs light that is representative of the first region and having a first polarization state toward the camera and (ii) the polarizing beam splitter directs light that is representative of the second region and having a different second polarization state toward the camera.

9. The vehicular cabin monitoring system of claim 8, wherein the camera comprises an imager, and wherein a polarization selector is disposed between the polarizing beam splitter and the imager, and wherein the polarization selector is operable between (i) a first state where light incident at the polarization selector and having the first polarization state passes through the polarization selector to be incident at the imager and light incident at the polarization selector and having the second polarization state does not pass through the polarization selector and (ii) a second state where light incident at the polarization selector and having the second polarization state passes through the polarization selector to be incident at the imager and light incident at the polarization selector and having the first polarization state does not pass through the polarization selector, and wherein, with the polarization selector operating in the first state, the camera views the first region, and wherein, with the polarization selector operating in the second state, the camera views the second region.

10. The vehicular cabin monitoring system of claim 8, wherein the camera comprises an imager, and wherein the imager comprises (i) a first set of pixels that capture image data representative of light incident at the imager and having the first polarization state and (ii) a second set of pixels that capture image data representative of light incident at the imager and having the second polarization state.

11. The vehicular cabin monitoring system of claim 7, wherein the mirror head accommodates a first lens and a second lens, and wherein light that is representative of 39
the first region and that is incident at the mirror reflective element (i) passes through the first lens to be incident at the beam splitter and (ii) is directed by the beam splitter toward the camera, and wherein light that is representative of the second region and that passes through the aperture in the mirror head (a) passes through the second lens to be incident at the beam splitter and (b) is directed by the beam splitter toward the camera.

12. The vehicular cabin monitoring system of claim 11, wherein at least one selected from the group consisting of (i) the first lens comprises a negative lens having a field of view with a width of at least 40 degrees and (ii) the second lens comprises a negative lens having a field of view with a width of at least 40 degrees.

13. The vehicular cabin monitoring system of claim 11, wherein at least one selected from the group consisting of (i) the first lens comprises a fisheye lens and (ii) the second lens comprises a fisheye lens, and wherein an optical relay is disposed between the fisheye lens and the beam splitter so that light transmitted by the fisheye lens is transmitted by the optical relay to be incident at the beam splitter.

14. The vehicular cabin monitoring system of claim 1, wherein a first near infrared light emitter is accommodated by the mirror head of the interior rearview mirror assembly, and wherein, with the interior rearview mirror assembly mounted at the interior portion of the interior cabin of the vehicle, the first near infrared light emitter is electrically operable to emit near infrared light to illuminate at least the first region of the interior cabin of the vehicle, and wherein a first portion of image data captured by the camera is representative of near infrared light reflected from surfaces within the first region of the cabin of the vehicle, and wherein a second near infrared light emitter is accommodated by the mirror head of the interior rearview mirror assembly, and wherein, with the interior rearview mirror assembly mounted at the interior portion of the interior cabin of the vehicle, the second near infrared light emitter is electrically operable to emit near infrared light to illuminate at least the second region of the interior cabin of the vehicle, and wherein a second portion of image data captured by the camera is representative of near infrared light reflected from surfaces within the second region of the cabin of the vehicle.

15. The vehicular cabin monitoring system of claim 14, wherein the first near infrared light emitter emits near infrared light with a first time cadence and the second near infrared light emitter emits near infrared light with a second time cadence different from the first time cadence, and wherein the first portion of image data is captured by the camera during the first time cadence and the second portion of image data is captured by the camera during the second time cadence.

16. The vehicular cabin monitoring system of claim 14, wherein the first near infrared light emitter emits near infrared light at a first wavelength and the second near infrared light emitter emits near infrared light at a second wavelength different from the first wavelength, and wherein the first portion of image data is representative of near infrared light at the first wavelength and the second portion of image data is representative of near infrared light at the second wavelength.

17. A vehicular cabin monitoring system, the vehicular cabin monitoring system comprising:an interior rearview mirror assembly comprises a mirror head adjustable about a mounting structure, wherein the mounting structure is configured to mount the interior rearview mirror assembly at an interior portion of an interior cabin of a vehicle;wherein the mirror head accommodates a mirror reflective element, a first lens and a second lens;wherein a camera is accommodated by the mirror head, and wherein, with the interior rearview mirror assembly mounted at the interior portion of the interior cabin of the vehicle, the camera views within the interior cabin of the vehicle;wherein the camera viewing within the interior cabin of the vehicle has a first field of view and a second field of view;wherein a first region within the interior cabin of the vehicle is within the first field of view of the camera, and wherein a second region within the interior cabin of the vehicle is within the second field of view of the camera, and wherein the second region of the interior cabin of the vehicle is different from the first region of the interior cabin of the vehicle;
wherein the camera views the first region within the interior cabin of the vehicle via the first lens, and wherein the camera views the second region within the interior cabin of the vehicle via the second lens;
wherein an optical element is accommodated by the mirror head, and wherein light that is representative of the first region (i) passes through the first lens to be incident at the optical element and (ii) is directed by the optical element toward the camera, and wherein light that is representative of the second region (a) passes through the second lens to be incident at the optical element and (b) is directed by the optical element toward the camera;
wherein at least one selected from the group consisting of (i) the first lens comprises a negative lens having a field of view with a width of at least 40 degrees and (ii) the second lens comprises a negative lens having a field of view with a width of at least 40 degrees;
wherein the camera and the mirror reflective element move together and in tandem with the mirror head when, with the interior rearview mirror assembly mounted at the interior portion of the interior cabin of the vehicle, the mirror head is adjusted about the mounting structure to provide a rearward view for a driver of the vehicle viewing the mirror reflective element;
an electronic control unit (ECU);
wherein image data captured by the camera is transferred to the ECU;
wherein the ECU comprises electronic circuitry and associated software, and wherein the electronic circuitry of the ECU comprises an image processor operable to process image data transferred to the ECU; and
wherein, with the interior rearview mirror assembly mounted at the interior portion of the interior cabin of the vehicle, (i) image data captured by the camera and representative of the first region is processed at the ECU for monitoring at least the driver of the vehicle and (ii) image data captured by the camera and representative of the second region is processed at the ECU for monitoring at least a passenger region within the interior cabin of the vehicle.

18. The vehicular cabin monitoring system of claim 17, wherein the camera views the first region within the interior cabin of the vehicle and the second region within the interior cabin of the vehicle through the mirror reflective element.

19. A vehicular cabin monitoring system, the vehicular cabin monitoring system comprising:an interior rearview mirror assembly comprises a mirror head adjustable about a mounting structure, wherein the mounting structure is configured to mount the interior rearview mirror assembly at an interior portion of an interior cabin of a vehicle;wherein the mirror head accommodates a mirror reflective element, a first lens and a second lens;wherein a camera is accommodated by the mirror head, and wherein, with the interior rearview mirror assembly mounted at the interior portion of the interior cabin of the vehicle, the camera views within the interior cabin of the vehicle;wherein the camera viewing within the interior cabin of the vehicle has a first field of view and a second field of view;wherein a first region within the interior cabin of the vehicle is within the first field of view of the camera, and wherein a second region within the interior cabin of the vehicle is within the second field of view of the camera, and wherein the second region of the interior cabin of the vehicle is different from the first region of the interior cabin of the vehicle;wherein the camera views the first region within the interior cabin of the vehicle via the first lens, and wherein the camera views the second region within the interior cabin of the vehicle via the second lens;wherein an optical element is accommodated by the mirror head, and wherein light that is representative of the first region (i) passes through the first lens to be incident at the optical element and (ii) is directed by the optical element toward the camera, and wherein light that is representative of the second region (a) passes through the second lens to be incident at the optical element and (b) is directed by the optical element toward the camera;wherein at least one selected from the group consisting of (i) the first lens comprises a fisheye lens and (ii) the second lens comprises a fisheye lens, and wherein an optical relay is disposed between the fisheye lens and the optical element so that light 43
transmitted by the fisheye lens is transmitted by the optical relay to be incident at the optical element;wherein the camera and the mirror reflective element move together and in tandem with the mirror head when, with the interior rearview mirror assembly mounted at the interior portion of the interior cabin of the vehicle, the mirror head is adjusted about the mounting structure to provide a rearward view for a driver of the vehicle viewing the mirror reflective element;an electronic control unit (ECU);wherein image data captured by the camera is transferred to the ECU;wherein the ECU comprises electronic circuitry and associated software, and wherein the electronic circuitry of the ECU comprises an image processor operable to process image data transferred to the ECU; andwherein, with the interior rearview mirror assembly mounted at the interior portion of the interior cabin of the vehicle, (i) image data captured by the camera and representative of the first region is processed at the ECU for monitoring at least the driver of the vehicle and (ii) image data captured by the camera and representative of the second region is processed at the ECU for monitoring at least a passenger region within the interior cabin of the vehicle.

20. The vehicular cabin monitoring system of claim 19, wherein the optical element comprises a beam splitter, and wherein (i) the beam splitter directs light that is representative of the first region and incident at the mirror reflective element toward the camera and (ii) the beam splitter directs light that is representative of the second region and that passes through an aperture in the mirror head toward the camera.
